(19) United States
(12) Patent Application Publication
(10) Pub. No.: US 2003/0003861 A1
(43) Pub. Date: Jan. 2, 2003

(54) Data broadcast-program production system, data broadcast-program method, data broadcast- program production computer-program, and computer-readable recorded medium

(76) Inventors: Hideki Kagemoto, Nara (JP); Toshiya Mori, Osaka (JP)

Correspondence Address: Joseph W Price, Price and Gess, 2100 S E Main Street Suite 250, Irvine, CA, 92614, US

(21) Appl. No.: 10/181,788

(22) PCT Filed: Dec. 6, 2001
(86) PCT No.: PCT/JP01/10664

(30) Foreign Application Priority Data
Dec. 7, 2000 (JP) 2000372627

(51) Int. Cl. H04H 1/00; H04N 7/16

(52) U.S. Cl. 455/3.01; 725/143

(57) ABSTRACT

In a data broadcast program production system of a broadcast station and a local broadcast station, the key broadcast station distributes raw data that has been obtained from an external raw data provision apparatus to the local broadcast station. Distribution setting information that lists a corresponded distribution target and raw data identifier is stored in a raw data net distribution information storage unit of a data broadcast program production apparatus at the key station. A raw data net distribution unit judges whether raw data received from a first data provision apparatus matches the raw data identifier listed in the distribution setting information, and when the two match, distributes the raw data to the local broadcast station data broadcast program production apparatus that is the distribution target.

### TECHNICAL FIELD

The present invention relates to a data broadcast program production system for digital broadcasting.

### BACKGROUND ART

Conventionally, in terrestrial television broadcasts a program that is produced at a key station is distributed to local stations and the local stations broadcast the distributed program as is. Similarly, in satellite broadcasting, a program that is broadcast via satellite is received by CATV stations, and each CATV receiver re-transmits the program.

However, data broadcast programs are not distributed from a key station to local stations, but rather are produced by the various stations. Here, data broadcast program denotes, for example, information programs such as news, weather, and traffic information that are independent of the main program, and can be selected and viewed at any time.

Taking weather information as one example, the key station may broadcast national weather and Kanto regional weather, whereas a Kyushu local station may broadcast national weather and Kyushu regional weather. Here, not all of the weather information is common to the two stations. Consequently, both the key station and the local station must obtain raw data for the weather information and produce their own weather forecast data broadcast program.

### DISCLOSURE OF THE INVENTION

The first object of the present invention is to provide a data broadcast program production system that is capable of distributing common raw data mutually between a plurality of broadcast stations.

The second object of the present invention is to provide a data broadcast program production system that further improves the distribution of raw data by distributing data broadcast program elements mutually between a plurality of broadcast stations, while maintaining the originality of each broadcast station.

The above-described first object is achieved by a data broadcast program production system that includes a first broadcast station data broadcast program production apparatus and a second broadcast station data broadcast program production apparatus, the first broadcast station data broadcast program production apparatus comprising: a distribution information storage unit for storing distribution information in which at least one raw data identifier and a raw data distribution target are corresponded; and raw data distribution unit for, when raw data is received from an external raw data provision device, selecting a piece of raw data whose identifier is in the distribution information, and distributing the selected piece of raw data to the second broadcast station data broadcast program production apparatus, the second broadcast station data broadcast program production apparatus being the corresponded raw data distribution target.

According to this construction, necessary raw data can be distributed mutually between a plurality of broadcast stations, therefore it is not necessary for each broadcast station to receive the same raw data from an external raw data provision apparatus.

Furthermore, the first broadcast station data broadcast program production apparatus may further include: a first template storage unit for storing a first template for a data broadcast program; and a first synthesis unit for receiving notification of both the selected piece of raw data and one or more pieces of raw data that were not selected by the distribution unit, and synthesizing the notified pieces of raw data, using the first template, to produce a data broadcast program element that composes a data broadcast program, and the second broadcast station data broadcast program production apparatus may include: a second template storage unit for storing a second template for a data broadcast program; and a second synthesis unit for receiving at least one piece of raw data from another external raw data provision apparatus and receiving the piece of raw data distributed from the first broadcast station data broadcast production apparatus, and synthesizing the received pieces of raw data, using the second template, to produce a data broadcast program element that composes a data broadcast program.

According to this construction, as well as using common raw data to synthesize a data broadcast program element, it is also possible for different broadcast stations to synthesize data broadcast program elements using original raw data.

Furthermore, the first broadcast station data broadcast program production apparatus may further include: a program schedule storage unit for storing a program schedule that lists a broadcast time for each scene of a broadcast program that is broadcast simultaneously with a data broadcast program, each scene having a scene identifier, each piece of raw data may have a scene identifier that corresponds to a scene, and the raw data distribution unit may distribute the selected piece of raw data in accordance with the broadcast time of the scene of the broadcast program corresponding to the scene identifier of the raw data.

According to this construction, when the data broadcast program is related to the ordinary broadcast program, it is possible to distribute raw data so that it is provided when the related scene in the ordinary program is broadcast.

The above-described second object is achieved by a data broadcast program production system that includes a first broadcast station data broadcast program production apparatus and a second broadcast station data broadcast program production apparatus, the first broadcast station data broadcast program production apparatus including: a template storage unit for storing a template for a data broadcast program; a synthesis unit for, on receiving raw data, synthesizing the received raw data, using the template, to produce a data broadcast program element that composes a data broadcast program, and appending an identifier to the data broadcast program element; a distribution information storage unit for storing distribution information in which at least one data broadcast program element identifier and a data broadcast program element distribution target are corresponded; and a data broadcast program element distribution unit for, on receiving notification of at least one produced data broadcast program element from the synthesis unit, selecting a data broadcast program element whose identifier is shown in the distribution information, and distributing the selected data broadcast program element to the second broadcast station data broadcast program production apparatus, the second broadcast station data broadcast program production apparatus corresponding to the distribution target.

According to this construction, data broadcast program elements that compose a data broadcast program can be mutually shared between a plurality of broadcast stations.

Furthermore, the second broadcast station data broadcast program production apparatus may include: a reception unit for receiving the data broadcast program element distributed from the first broadcast station data broadcast program production apparatus; a unique template storage unit for storing a unique template used to generate a unique data broadcast program element from the received data broadcast program element; and a synthesis unit for synthesizing a unique data broadcast program element from the received data broadcast program element, using the unique template.

According to this construction, a second broadcast station data broadcast program production device is able modify and use a data broadcast program element synthesized by a first broadcast station data broadcast program production apparatus as its own data broadcast program element.

Furthermore, the first broadcast station data broadcast program production apparatus may further include: a conversion/transmission unit for receiving notification of a data broadcast program element from the data broadcast program element distribution unit, converting the data broadcast program element to a transport stream, and transmitting the transport stream, wherein the data broadcast program element distribution unit appends a time stamp to the data broadcast program element, the time stamp being a time that is the amount of required for distribution of the data broadcast program element to the second broadcast station broadcast program production apparatus added to a current time, and the conversion/transmission unit transmits the transport stream in compliance with the time stamp; and the second broadcast station broadcast program production apparatus may further include: a conversion unit for, in compliance with the time stamp, converting the received data broadcast program element to a transport stream and transmitting the transport stream.

According to this construction, transmission of a data broadcast program element from the first broadcast station to the second station can be synchronized with an absolute time, taking into consideration the time required to distribute the data broadcast program element.

Furthermore, the second broadcast station data broadcast program production apparatus may further include: a delay information storage unit for storing delay information that shows an amount of time required for distribution of a broadcast program from the first broadcast station, and the conversion unit may delay transmission of the transport stream by the amount of time shown in the delay information.

According to this construction, when a data broadcast program is related to an ordinary program, transmission of the data broadcast program can be delayed taking into consideration the time required to distribute the broadcast program from the first broadcast station to the second broadcast station. Therefore, it is possible to provide the data broadcast program according to the flow of the broadcast program.

Furthermore, the data broadcast program production apparatus is a data broadcast program production system that includes a first broadcast station data broadcast program production apparatus and a second broadcast station data broadcast program production apparatus, the first broadcast station data broadcast program production apparatus including: a template storage unit for storing a template for a data broadcast program; a module synthesis unit for, on receiving raw data, synthesizing the raw data, using the template, to produce a module that composes a data broadcast program, and appending a module identifier to the module; a distribution information storage unit for storing distribution information in which at least one module identifier and a distribution target are corresponded; and a module distribution unit for, on receiving notification of one or more synthesized modules from the module synthesis means, selecting a module shown by the module identifier in the distribution information, and distributing to the second broadcast station data broadcast program production apparatus that corresponds to the distribution target.

According to this construction, a module synthesized by a first broadcast station data broadcast program production apparatus can be distributed to and used as is in a second broadcast station data broadcast program production apparatus.

Furthermore, the above-described first object is achieved by a data broadcast program production method for a first broadcast station and a second broadcast station, the method including at the first broadcast station: a distribution information storage step for storing distribution information in which at least one raw data identifier and a raw data distribution target are corresponded; and a raw data distribution step for, when raw data is received from an external raw data provision device, selecting a piece of raw data whose identifier is in the distribution information, and distributing the selected piece of raw data to the second broadcast station data broadcast program production apparatus, the second broadcast station data broadcast program production apparatus being the corresponded raw data distribution target.

According to this method, it is possible to distribute raw data that is required mutually between a plurality of broadcast stations.

The above-described second object is achieved by a data broadcast program production method for a first broadcast station and a second broadcast station, the method including at the first broadcast station: a template storage step for storing a template for a data broadcast program; a synthesis step for, on receiving raw data, synthesizing the received raw data, using the template, to produce a data broadcast program element that composes a data broadcast program, and appending an identifier to the data broadcast program element; a distribution information storage step for storing distribution information in which at least one data broadcast program element identifier and a data broadcast program element distribution target are corresponded; and a data broadcast program element distribution step for, on receiving notification of at least one produced data broadcast program element at the synthesis step, selecting a data broadcast program element whose identifier is shown in the distribution information, and distributing the selected data broadcast program element to the second broadcast station data broadcast program production apparatus, the second broadcast station data broadcast program production apparatus corresponding to the distribution target.

According to this method, data broadcast program elements that compose a data broadcast program can be shared mutually by a plurality of broadcast stations.

Furthermore, above-described second object is achieved by computer program that executes on a computer a data broadcast program production method for a first broadcast station and a second broadcast station, the method including at the first broadcast station: a template storage step for storing a template for a data broadcast program; a synthesis step for, on receiving raw data, synthesizing the received raw data, using the template, to produce a data broadcast program element that composes a data broadcast program, and appending an identifier to the data broadcast program element; a distribution information storage step for storing distribution information in which at least one data broadcast program element identifier and a data broadcast program element distribution target are corresponded; and a data broadcast program element distribution step for, on receiving notification of at least one produced data broadcast program element at the synthesis step, selecting a data broadcast program element whose identifier is shown in the distribution information, and distributing the selected data broadcast program element to the second broadcast station data broadcast program production apparatus, the second broadcast station data broadcast program production apparatus corresponding to the distribution target.

By using such a program, data broadcast program elements can be shared mutually by a plurality of broadcast stations.

In addition, the above-described second object is achieved by a computer-readable recording medium for use in a first broadcast station data broadcast program production apparatus and a second data broadcast station data broadcast program production apparatus, and having recorded there on a computer program that has a computer execute: a template storage step for storing a template for a data broadcast program; a synthesis step for, on receiving raw data, synthesizing the received raw data, using the template, to produce a data broadcast program element that composes a data broadcast program, and appending an identifier to the data broadcast program element; a distribution information storage step for storing distribution information in which at least one data broadcast program element identifier and a data broadcast program element distribution target are corresponded; and a data broadcast program element distribution step for, on receiving notification of at least one produced data broadcast program element at the synthesis step, selecting a data broadcast program element whose identifier is shown in the distribution information, and distributing the selected data broadcast program element to the second broadcast station data broadcast program production apparatus, the second broadcast station data broadcast program production apparatus corresponding to the distribution target.

By using this kind of recording medium in a data broadcast program production system, data broadcast program elements can be distributed mutually between a plurality of broadcast stations.

### BRIEF DESCRIPTION OF THE DRAWINGS

FIG. 1 is a structural drawing of a first embodiment of the data broadcast program production system of the present invention;

FIG. 2 shows an example of a data broadcast program produced by a key broadcast station data broadcast program production apparatus of the aforementioned embodiment;

FIG. 3 shows visually an outline of synthesis of the data broadcast program shown in FIG. 2;

FIG. 4 is an explanatory drawing of a template that is stored in the template storage unit of the key broadcast station of the aforementioned embodiment;

FIG. 5 shows details of synthesis instruction information included in a program template;

FIG. 6 shows details of a BML replacement list included in the program template;

FIG. 7 shows part of the details of lists included in the program template;

FIG. 8 shows an example of net distribution setting information and an IP address correspondence table stored in a raw data net distribution information storage unit of the key broadcast station data broadcast program production apparatus of the aforementioned embodiment;

FIG. 9 shows an example of raw data obtained by a raw data net distribution unit of the aforementioned embodiment from a first data provision apparatus;

FIG. 10 describes schematically synthesis of a data broadcast program in the aforementioned embodiment;

FIG. 11 shows an outline of synthesis of a data broadcast program produced by a local broadcast station data broadcast program production apparatus of the aforementioned embodiment;

FIG. 12 shows a program template stored in a template storage unit of the local broadcast station of the aforementioned embodiment;

FIG. 13 shows details of synthesis instruction information included in the program template;

FIG. 14 shows details of a BML replacement list included in the program template;

FIG. 15 shows an example of the raw data obtained by the raw data net distribution unit of the aforementioned embodiment from a second data provision apparatus;

FIG. 16 is a flowchart describing operations of the key broadcast station data broadcast program production apparatus of the aforementioned embodiment;

FIG. 17 is a flowchart describing operations of the local broadcast station data broadcast program production apparatus of the aforementioned embodiment;

FIG. 18 is a flowchart describing operations at S1604 in the flowchart in FIG. 16 in detail;

FIG. 19 is a flowchart describing operations at S1612 in the flowchart in FIG. 16 in detail;

FIG. 20 is a structural drawing of a second embodiment of the data broadcast program production system of the present invention;

FIG. 21 shows an example of program schedule information stored in a raw data net distribution unit of a key broadcast station data broadcast program production apparatus of the aforementioned embodiment;

FIG. 22 is a structural drawing of a third embodiment of the data broadcast program production system of the present invention;

FIG. 23 shows an example of net distribution setting information and an IP address correspondence table stored in a net distribution information storage unit of the key broadcast station data broadcast program production apparatus of the aforementioned embodiment;

FIG. 24 shows visually an outline of a data broadcast program produced by a local broadcast station data broadcast program production apparatus of the aforementioned embodiment;

FIG. 25 shows an example of the program template stored in a template storage unit of the local station data broadcast program production apparatus of the aforementioned embodiment;

FIG. 26 shows details of synthesis instruction information that composes the program template;

FIG. 27 is a structural drawing of a fourth embodiment of the data broadcast program production system of the present invention;

FIG. 28 shows an example of a data broadcast program element distributed from a key broadcast station data broadcast program production apparatus of the aforementioned embodiment;

FIG. 29 describes resources that compose the data broadcast program element shown in FIG. 28;

FIG. 30 shows an example of net distribution setting information and an IP address correspondence table stored in a net distribution information storage unit of the key broadcast station data broadcast program production apparatus of the aforementioned embodiment;

FIG. 31 shows an example of raw data obtained by a synthesis unit of the local broadcast station data broadcast program production apparatus of the aforementioned embodiment;

FIG. 32 shows an example of synthesis instruction information stored in a template storage unit of the local broadcast station data broadcast program production apparatus of the aforementioned embodiment;

FIG. 33 shows an example of a screen of a data broadcast program element synthesized by the synthesis unit of local broadcast station data broadcast program production apparatus of the aforementioned embodiment;

FIG. 34 is a structural drawing of a fifth embodiment of the data broadcast program production system of the present invention;

FIG. 35 shows an example of net distribution setting information and an IP address correspondence table stored in a net distribution information storage unit of the key broadcast station data broadcast program production apparatus of the aforementioned embodiment;

FIG. 36 is a structural drawing of a sixth embodiment of the data broadcast program production system of the present invention;

FIG. 37 shows an example of a screen when a data broadcast program element is broadcast in the aforementioned embodiment;

FIG. 38 shows the state of a switch between data broadcast program elements in the aforementioned embodiment;

FIG. 39 is a structural drawing of a seventh embodiment of the data broadcast program production system of the present invention;

FIG. 40 shows an example of delay information stored in a delay information storage unit of the aforementioned embodiment.

### BEST MODE FOR CARRYING OUT THE INVENTION

The following describes embodiments of the data broadcast program production system of the present invention, with use of the drawings.

Note that the following embodiments conform to the ARIB (Association of Radio Industries and Businesses) standard specification B24 1.0 “Data Broadcast Encoding Method and Transmission Method in Digital Broadcasting”, volume 2, paragraphs 9.1.1 to 9.1.2 “Content Transmission” and volume 3, chapter 6 “Data Carousel Transmission Method”.

First Embodiment

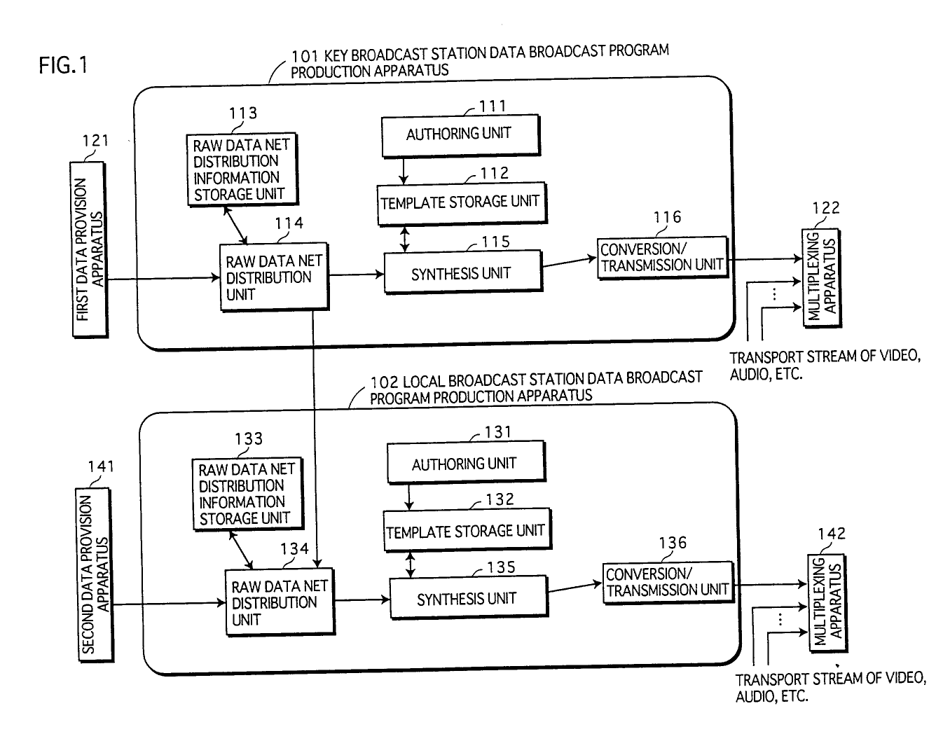

FIG. 1 is a structural drawing of the first embodiment of the data broadcast program production system of the present invention.

The data broadcast program production system is composed of a key broadcast station data broadcast program production apparatus 101 and a local broadcast station data broadcast program production apparatus 102.

The key broadcast station data broadcast program production apparatus 101 includes an authoring unit 111, a template storage unit 112, a raw data net distribution information storage unit 113, a raw data net distribution unit 114, a synthesis unit 115, and a conversion/transmission unit 116.

The raw data net distribution unit 114 is connected to an external first data provision apparatus 121. The conversion/transmission unit 116 is connected to an external multiplexing apparatus 122.

The local broadcast station data broadcast program production apparatus 102 includes an authoring unit 131, a template storage unit 132, a raw data net distribution information storage unit 133, a raw data net distribution unit 134, a synthesis unit 135, and a conversion/transmission unit 136. The raw data net distribution unit 134 and the conversion/transmission unit 136 are connected to an external second data provision apparatus 141 and an external multiplexing apparatus 142 respectively.

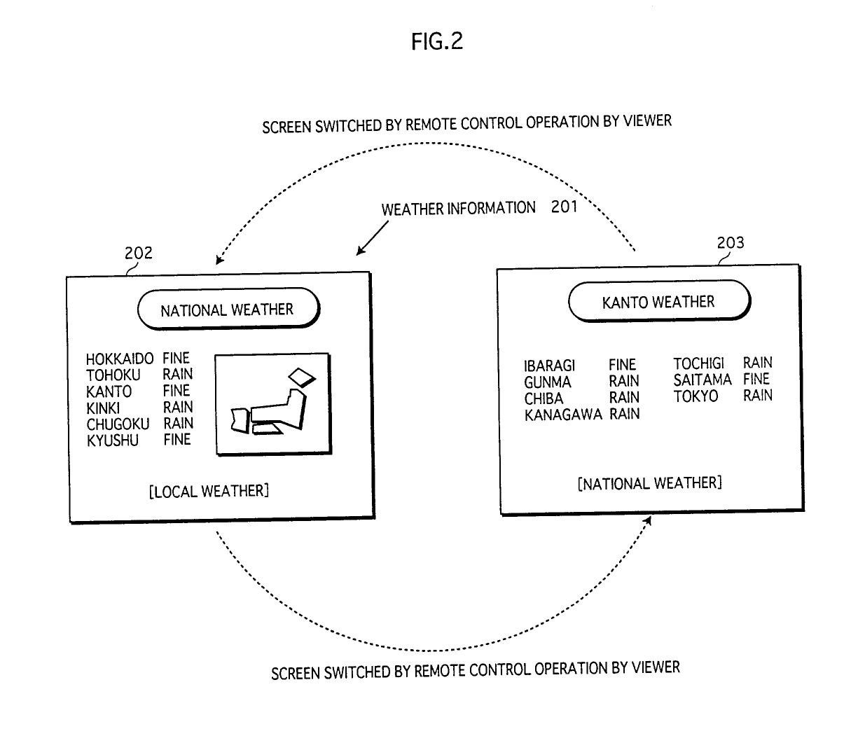

The key broadcast station data broadcast program production apparatus 101 is produces, for example, a data broadcast program “WEATHER INFORMATION” as shown in FIG. 2.

Note that “HOKKAIDO”, “TOHOKU”, “KANTO”, “KINKI”, “CHUGOKU”, and “KYUSHU” in “NATIONAL WEATHER” 202 are names of areas in Japan, and that “IBARAGI”, “GUNMA”, “CHIBA”, “KANAGAWA”, “TOCHIGI”, “SAITAMA”, and “TOKYO” in “KANTO WEATHER” 203 are names of prefectures in the Kanto area.

“WEATHER INFORMATION” 201 is composed of two data broadcast program elements “NATIONAL WEATHER” 202, and “KANTO WEATHER” 203. A viewer can switch between “NATIONAL WEATHER” 202 and “KANTO WEATHER” 203 with use of a remote control.

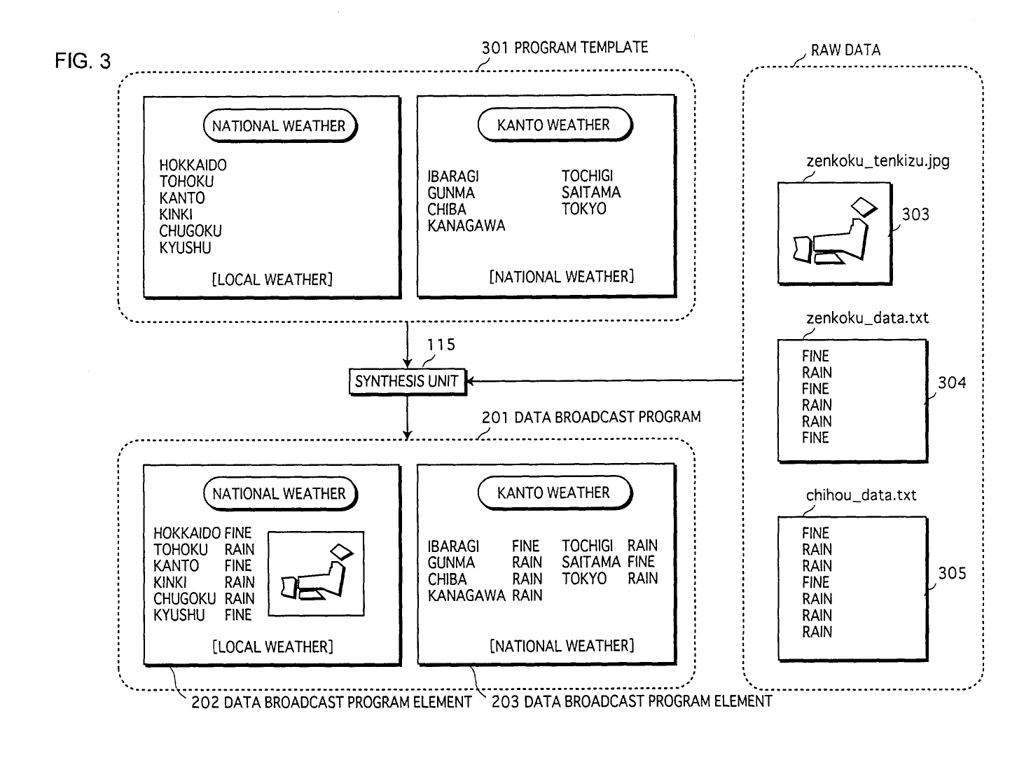

An outline of the production of the data broadcast program “WEATHER INFORMATION” 201 is shown in FIG. 3. A program template 301 produced using the authoring unit 111, and raw data 303, 304, and 305 obtained via the raw data net distribution unit 114 from the first data provision apparatus 121 are synthesized by the synthesis unit 115 to create the data broadcast program 201.

The authoring unit 111 produces the program template 301 according to input operations by a person producing the program. A program template 301 is produced for each data broadcast program element.

The template storage unit 112 stores the program template 301.

Here, the program template 301 consists only of information that does not change as time elapses and that has been produced in advance, such as the layout of the screen, and character strings and images that are ordinarily displayed on the screen. Information that changes as time elapses, such as the actual weather data (“fine”, “rain”, etc.) and weather map images, are obtained from an external device as raw data, and synthesized with the template program template 301 by the synthesis unit 115 to produce a data broadcast program element.

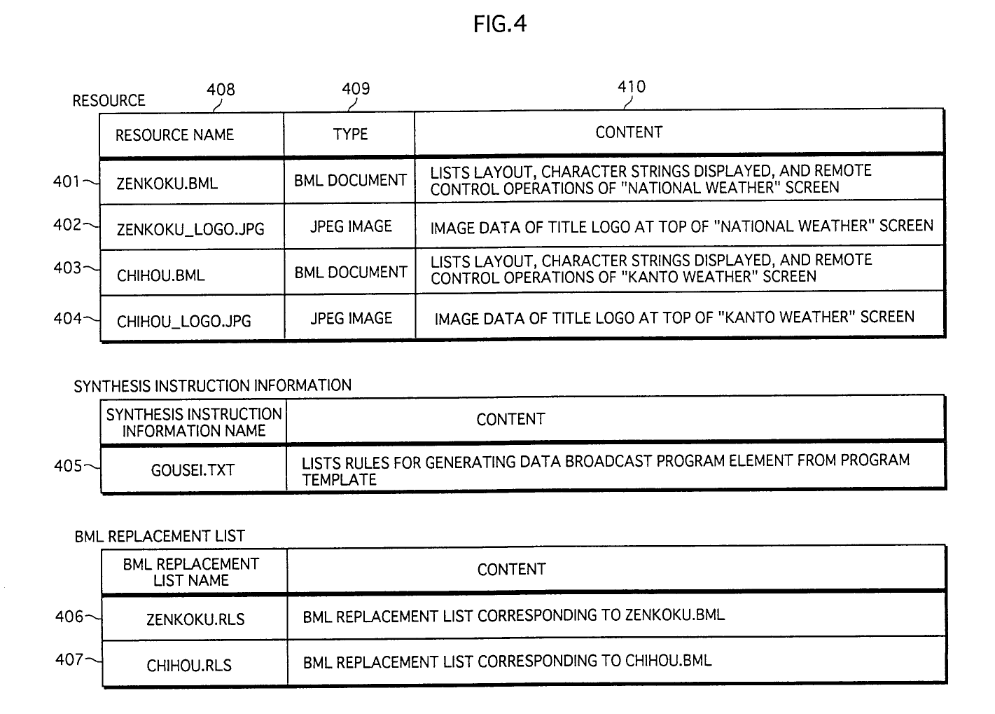

The program template 301 shown in FIG. 3 is composed of ARIB specification resources 401, 402, 403, and 404, synthesis instruction information 405, and BML replacement lists 406 and 407, all of which are shown in FIG. 4.

Each of the resources 401 to 404 is identified by a resource name 408, has a type 409 (either document or image), and includes data that is listed in a content column 410.

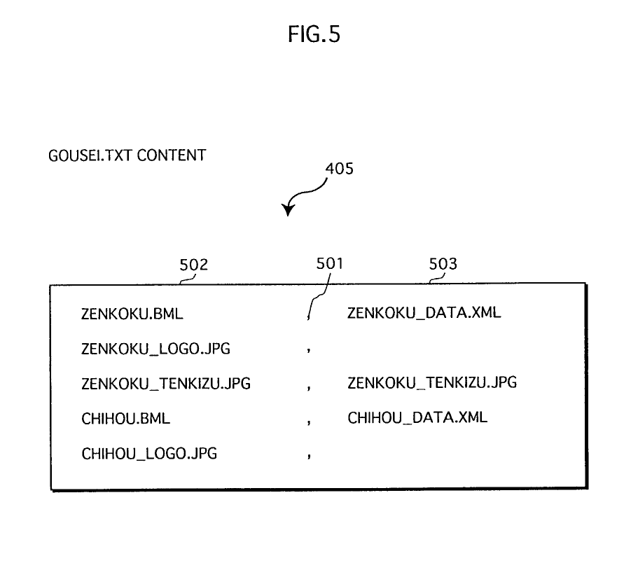

The synthesis instruction information 405 is identified by a synthesis instruction information name. Details of the contents of the synthesis instruction information 405 are shown in FIG. 5. The synthesis instruction information GOUSEI.TXT 405 is text, each line of which has two items that are separated by a comma 501. A first item 502 that comes before the comma 501 is the name of a resource that composes a data broadcast program element that has been generated according to synthesis processing. A second item 503 is a name of raw data that is used for generating the resource shown in the first item.

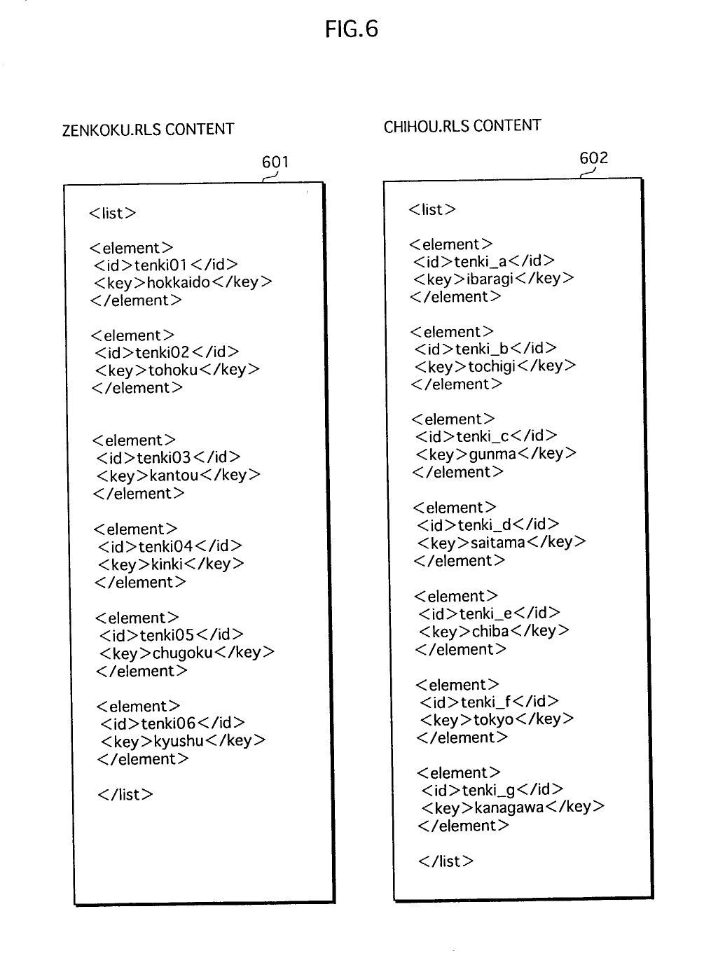

Details of the content of the BML replacement lists 406 and 407 are shown in FIG. 6.

The BML replacement list 406 is shown in content 601 of ZENKOKU.RLS, and the BML replacement list 407 is shown in content 602 of CHIHOU.RLS.

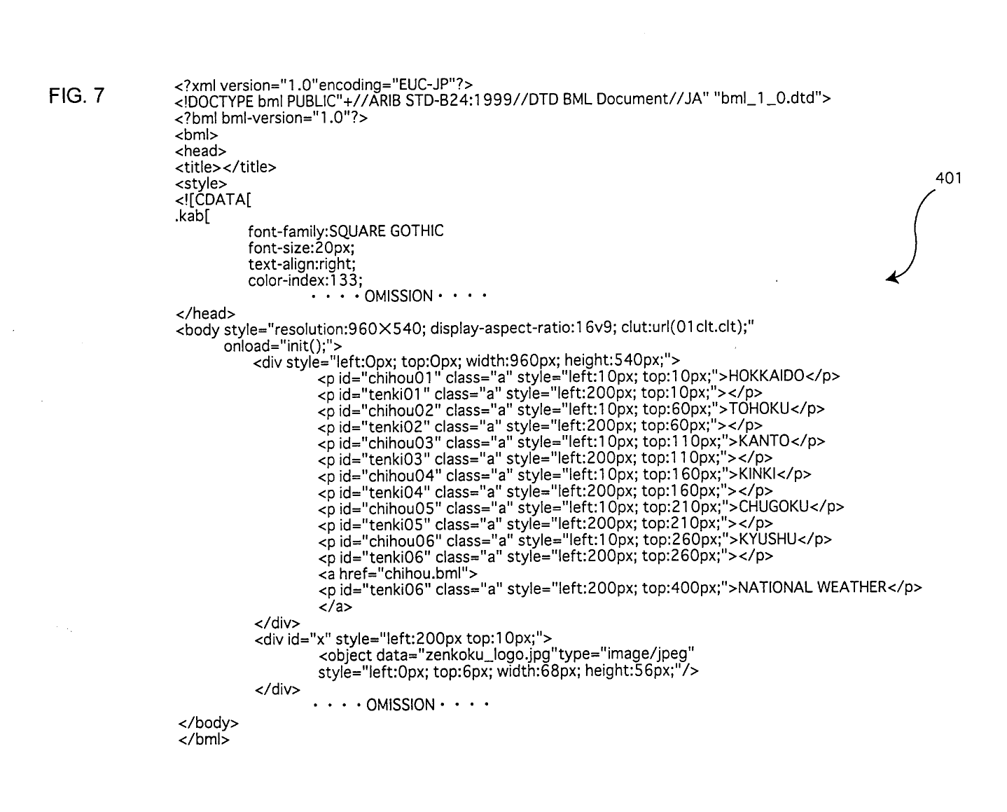

FIG. 7 shows part of the details of the resource 401 ZENKOKU.BML.

The raw data net distribution information storage unit 113 stores a net distribution setting information and an IP addresses correspondence table.

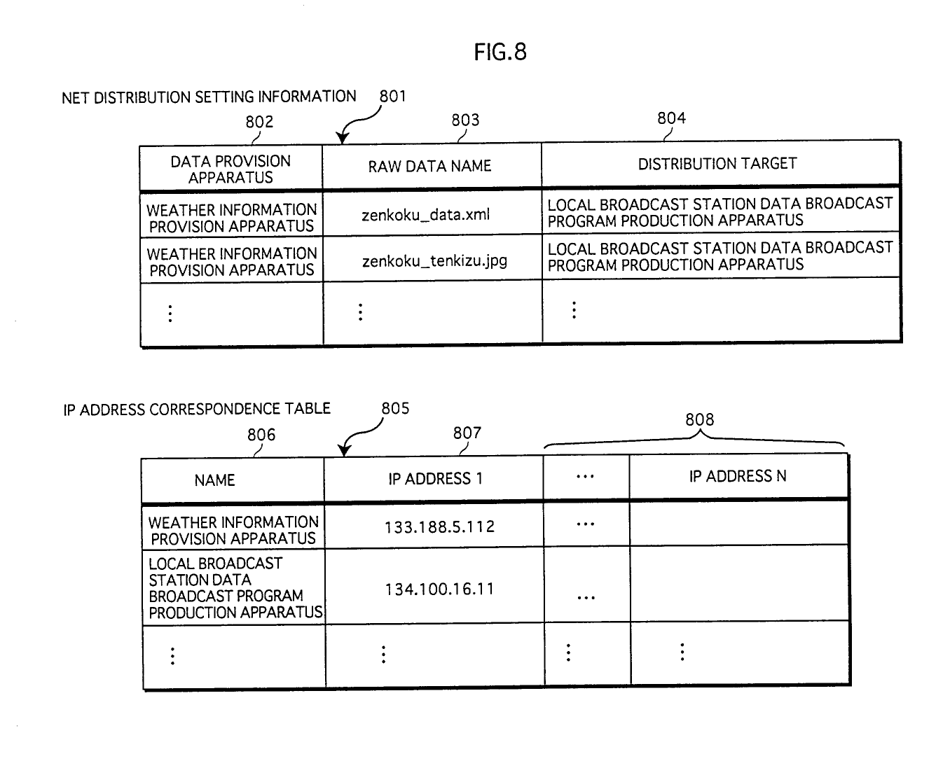

FIG. 8 shows an example of the net distribution setting information and the IP address correspondence table stored in the raw data net distribution information storage unit 113.

Net distribution setting information 801 is information that has been produced in advance by the person producing the program, and prescribes the operations of the raw data net distribution unit 114. A data provision apparatus column 802, a raw data name column 803, and a distribution target column 704 are provided in the net distribution setting information 801. According to the net distribution setting information 801, when raw data designated by the raw data name shown in the lines of the net distribution setting information 801 arrives from a data provision apparatus, the raw data net distribution unit 114 notifies the synthesis unit 115 of the raw data, as well as distributing the raw data to the distribution target.

Note that the data provision apparatus column 802 and the raw data name column 803 in the net distribution setting information 801 can shown a simple character string, or can shown a general wild card. The matching judgement algorithm for a wild card and a character string is widely known and is thus omitted here. For example, by specifying “weather information provision apparatus” as the data provision apparatus and “*.*” as the raw data name, a specification can be easily shown for distributing raw data provided from the weather information provision apparatus to all distribution targets.

The IP address correspondence table 805 shows the correspondence between the raw data distribution origin or target name 806 and the IP address 807. Here, it is supposed that raw data is distributed using TCP/IP, and that the IP address correspondence table 805 designates the distribution target of raw data and distinguishes the provision origin of arrived raw data.

In the key broadcast station data broadcast program production apparatus 101, the first data provision apparatus 121 is identified by a name “weather information provision apparatus”, and an IP address 133.188.5.112 is set to be used when communicating with the first data provision apparatus 121.

Note that a plurality of IP address columns 808 are provided in the IP address correspondence table. For example, by listing a plurality of IP addresses for local broadcast station data broadcast program production devices, it is possible to distribute one piece of raw data to a plurality of broadcast stations.

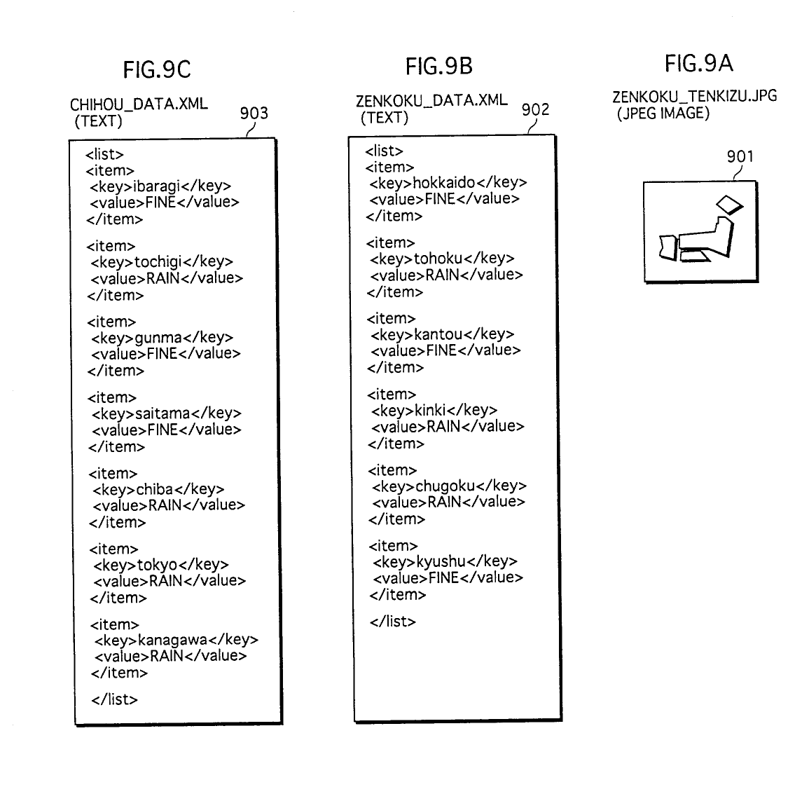

The first data provision apparatus 121 transmits raw data to the raw data net distribution unit of the key broadcast station data broadcast program production apparatus 101. Here, raw data denotes data that is synthesized with the program template 301 to make a data broadcast program element and that does not vary with time. For example, the raw data 303, 304, and 305 shown in FIG. 3 are transmitted. The raw data 303 is a weather map, and is transmitted as a JPEG image as shown in FIG. 9A. The raw data 304 and 305 are transmitted as text data as shown in FIGS. 9B and 9C respectively. Each of the raw data 901, 902, and 903 has a raw data name.

The raw data net distribution unit 114, on receiving raw data from the first data provision apparatus 121, judges whether the data provision apparatus that is the origin of transmission and the raw data name are shown in the net distribution setting information 801 stored in the raw data net distribution information storage unit 113. If they are not shown, the raw data net distribution unit 114 notifies the synthesis unit 115 of the raw data name. If they are shown, the raw data net distribution unit 114 notifies the synthesis unit 115 and distributes the raw data to the particular distribution target. Here, the raw data net distribution unit 114 refers to the IP address correspondence table 805 stored in the raw data net distribution information storage unit 113 to distribute the raw data addressed to the IP address corresponding to the distribution target.

For example, since the raw data name zenkoku_tenkizu.jpg of the weather map raw data 901 is listed in the second line of the net distribution setting information 801, the raw data 901 is distributed addressed to the IP address 134.100.16.11 of the local broadcast station data broadcast program production apparatus 102 which is the distribution target. Similarly, since the raw data name zenkoku_data.xml of the raw data 902 is listed in the first line of the net distribution setting information 801, the raw data 902 is distributed to the local broadcast station data broadcast program production apparatus 102 which is the distribution target.

Since the raw data name chihou_data.xml of the raw data 903 is not shown in the net distribution setting information 801, the raw data 903 is only notified to the synthesis unit 115.

On receiving the notification of the raw data from the raw data net distribution unit 114, the synthesis unit 115 refers to the synthesis instruction information 405 of the program template stored in the template storage unit 112. The synthesis unit 115 judges whether all the raw data in the second item 503 of the synthesis instruction information 405 has been notified, and when all the raw data has been notified, begins synthesis of the program template and the raw data.

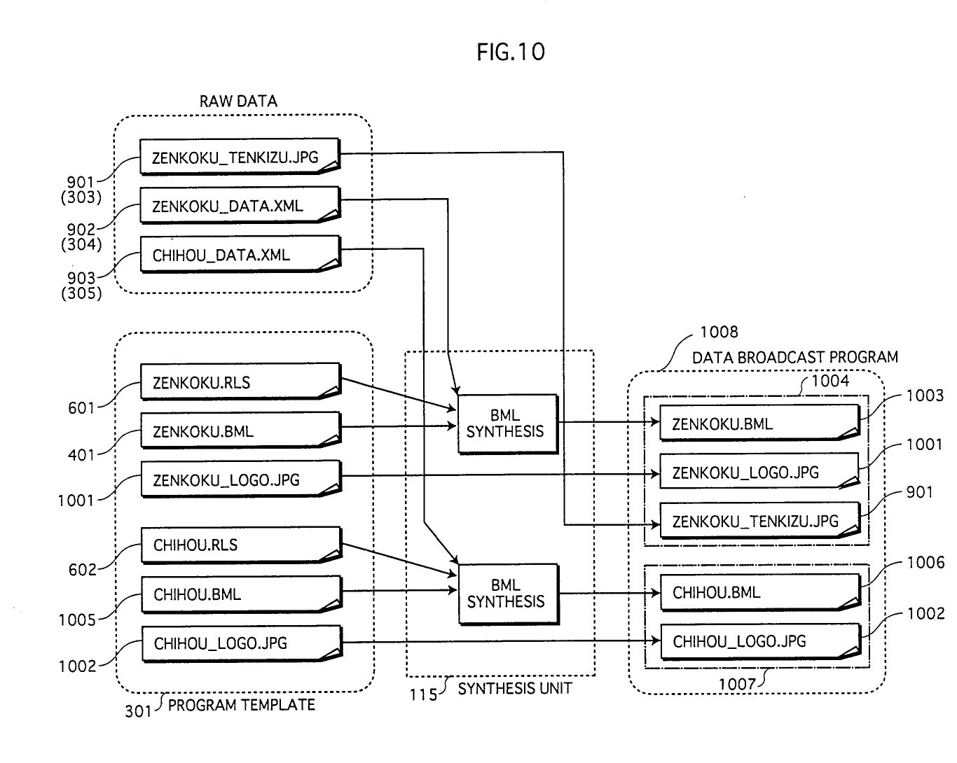

FIG. 10 describes schematically data broadcast program synthesis by the synthesis unit 115. This corresponds to that shown earlier in FIG. 3.

The synthesis unit 115 refers to the synthesis instruction information 405 (see FIG. 5), and generates the resource specified in the first item 502 of each line, according to the following procedure.

(1) When the second item 503 is blank, the synthesis unit 115 copies the resource with the same name in the program template, and makes the copied resource a resource of the data broadcast program element. For example, ZENKOKU_LOGO.JPG 1001 and CHIHOU_LOGO.JPG 1002.

(2) When the second item 503 is not blank and the resource type specified in the first item 502 is a type other than BML, the synthesis unit 115 copies the resource with the same name in the raw data, and makes the copied resource a resource of the data broadcast program element. For example, ZENKOKU_TENKIZU.JPG.

(3) When the second item 503 is not blank and the resource type specified in the first item 502 is BML, the synthesis unit 115 performs processing to synthesize BML embedded data (hereinafter “BML synthesis processing”) in the raw data specified by the second item 503 on the resource with the same name in the program template 301, and makes the processed resource a resource of the data broadcast program element.

Here, the BML synthesis processing is described in detail. When synthesizing a program template resource (BML type), for example resource ZENKOKU.BML 401 (see FIG. 7) with BML embedded data in raw data ZENKOKU_DATA.XML 902 (see FIG. 9B), the BML replacement list ZENKOKU.RLS 601 of the program template that corresponds to the resource is used.

Specifically, the synthesis unit 115 replaces the content of the id attribute “tenko01” of the ZENKOKU.BML with “fine”, which is the value of the key hokkaido of the ZENKOKU_DATA.XML that matches the key hokkaido of the id attribute “tenki01” of the element of the ZENKOKU.RLS 601. This processing replaces all elements of the ZENKOKU.RLS 601.

The result of this processing is a resource 1003, as shown in FIG. 10, in which part of the ZENKOKU.BML 401 in the program template 301 has been replaced with the embedded data of the ZENKOKU_DATA.XML 902. The resource 1003, a resource 1001, and the resource 901 compose a data broadcast program element 1004 (202).

Similarly, CHIHOU.BML 1005 in the program template 301 becomes a resource CHIHOU.BML 1006 obtained by using CHIHOU.RSL 602 to replace with the embedded data in the CHIHOU_DATA.XML 903. The resource 1006 and the resource 1002 compose a data broadcast program element 1007 (203).

On synthesizing a data broadcast program 1008 composed of the data broadcast program element 1004 and the data broadcast program element 1007, the synthesis unit 115 notifies the conversion/transmission unit 116 of the synthesized data broadcast program 1008.

The conversion/transmission unit 116 converts the data broadcast program elements 1004 and 1007 to an MPEG2 transport stream in a predetermined format, and repeatedly transmits the transport stream to the external multiplexing apparatus 122.

The external multiplexing apparatus 122 multiplexes the transport stream of the data broadcast program elements 1004 and 1007 and a transport streams of audio, video and the like, and transmits the result.

The following describes the local broadcast station data broadcast program production apparatus 102.

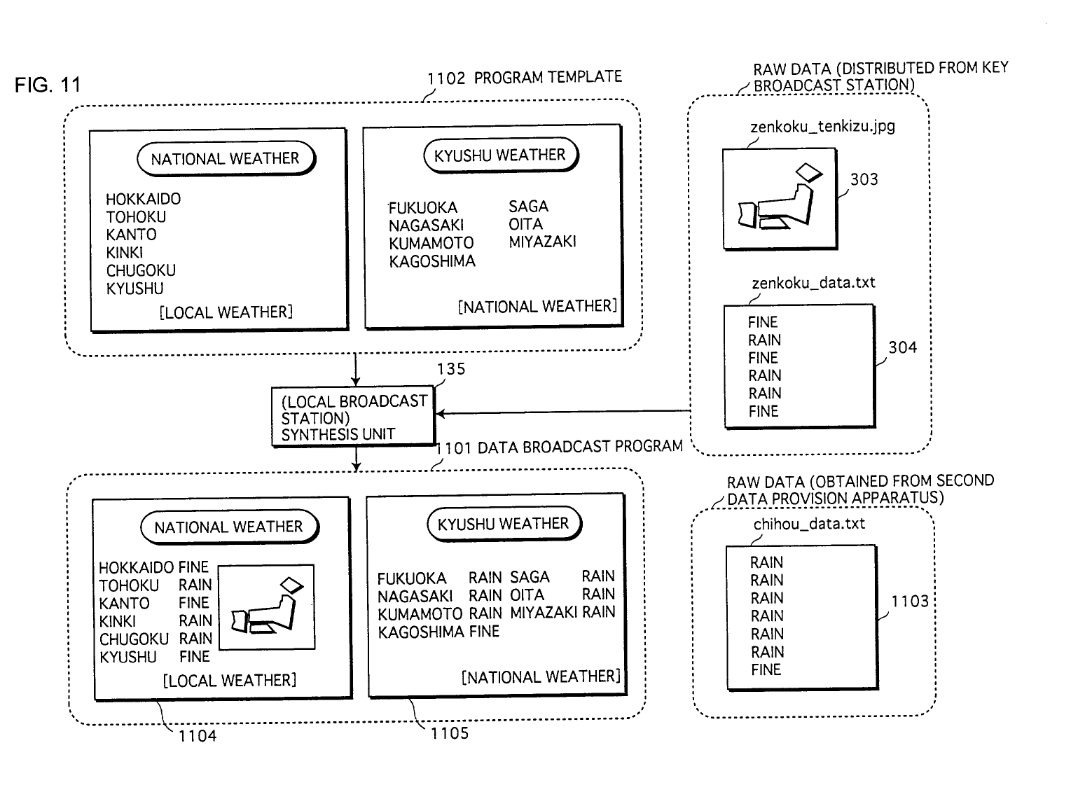

FIG. 11 describes an outline of production of a data broadcast program 1101 by the local broadcast station data broadcast program production apparatus 102 visually. A program template 1102 is produced with use of the authoring unit 131 by the person producing the program, and stored in the template storage unit 132.

The raw data 303 and 304 distributed from the key broadcast station data broadcast program production apparatus 101 and the raw data 1103 obtained from the second data provision apparatus 141 are notified to the synthesis unit 135 via the raw data net distribution unit 134.

The synthesis unit 135 synthesizes data broadcast program elements 1104 and 1105 from the program template 1102 and the raw data 303, 304 and 1103.

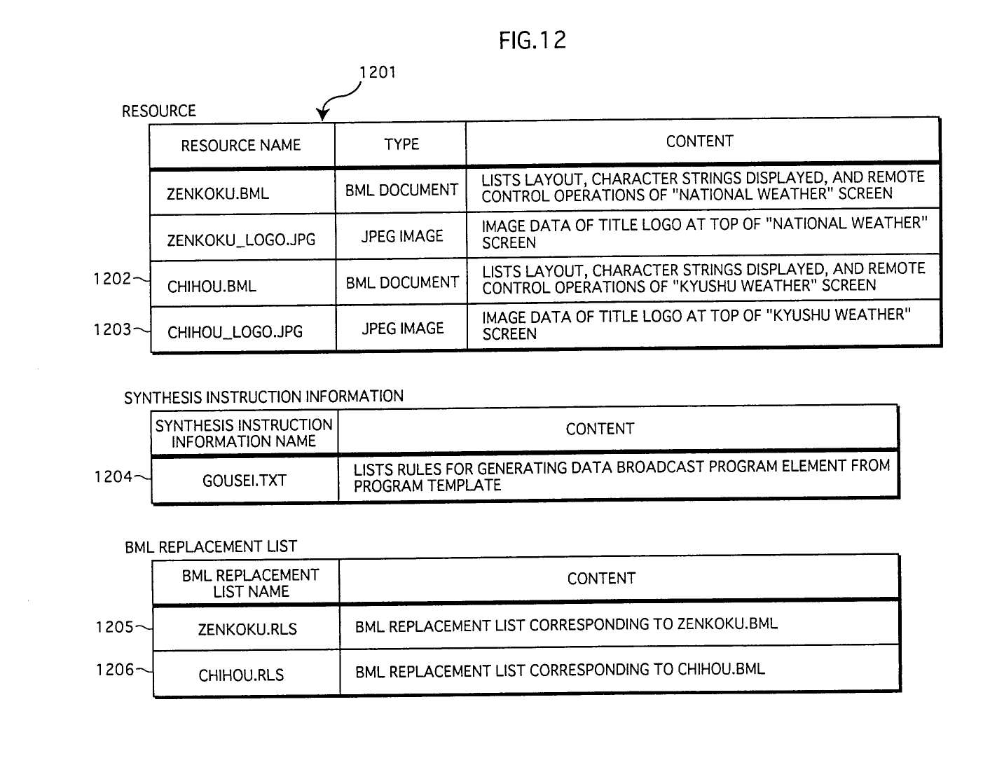

FIG. 12 shows an outline of the resources, synthesis instruction information and BML replacement lists that compose the program template 1102 stored in the template storage unit 132.

CHIHOU.BML 1202 and CHIHOU_LOGO.JPG 1203 of a resource 1201 are resources unique to the data program production apparatus 103.

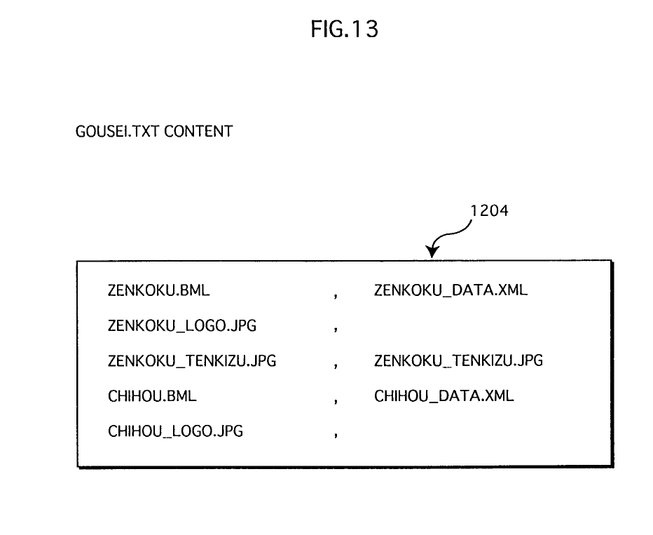

Details of synthesis instruction information 1204 are shown in FIG. 13.

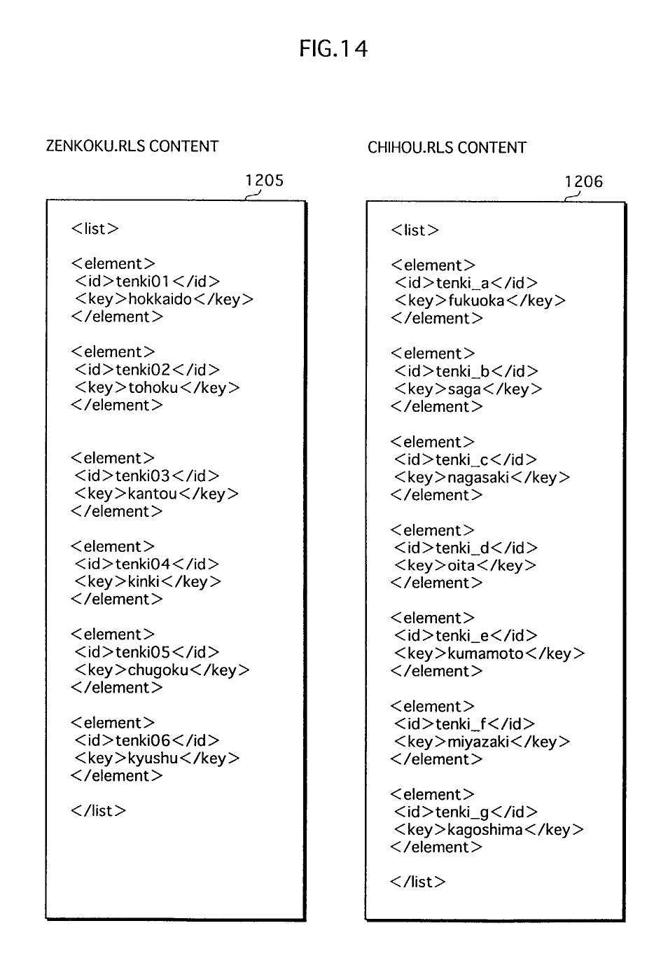

Details of BML replacement lists ZENKOKU.RLS 1205 and CHIHOU.RLS 1206 are shown in FIG. 14.

Net distribution setting information is not stored in the raw data net distribution information storage unit 133.

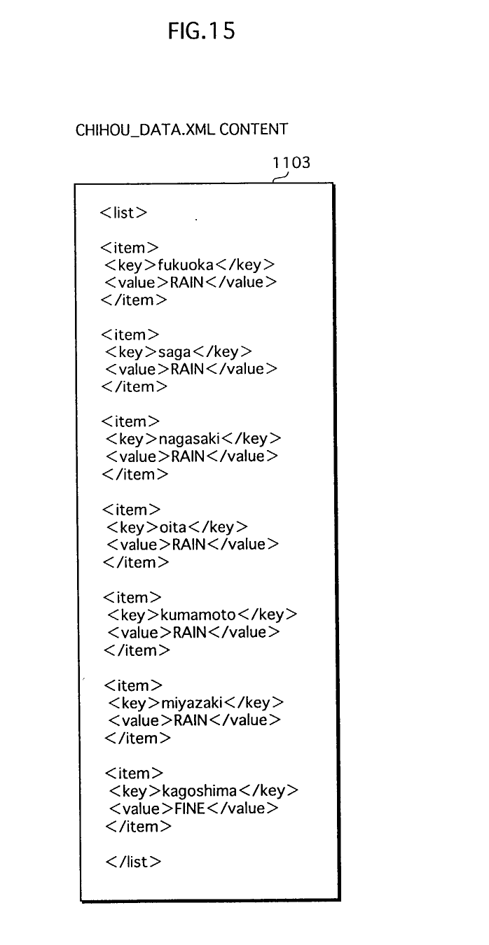

FIG. 15 shows an example of raw data CHIHOU_DATA.XML that arrives at the raw data net distribution unit 134 from the second data provision apparatus 141.

Note that since the structure of the local broadcast station data broadcast program production apparatus 102 does not differ from that of the key broadcast station data broadcast program production apparatus 101, a description of the functions of each unit of the local broadcast station data broadcast program production apparatus 102 is omitted. However, since there is no net distribution setting information stored in the raw data net distribution information storage unit 133, the raw data net distribution unit 134 does not distribute raw data received from the second data provision apparatus 141 to other broadcast stations' data broadcast program production apparatuses.

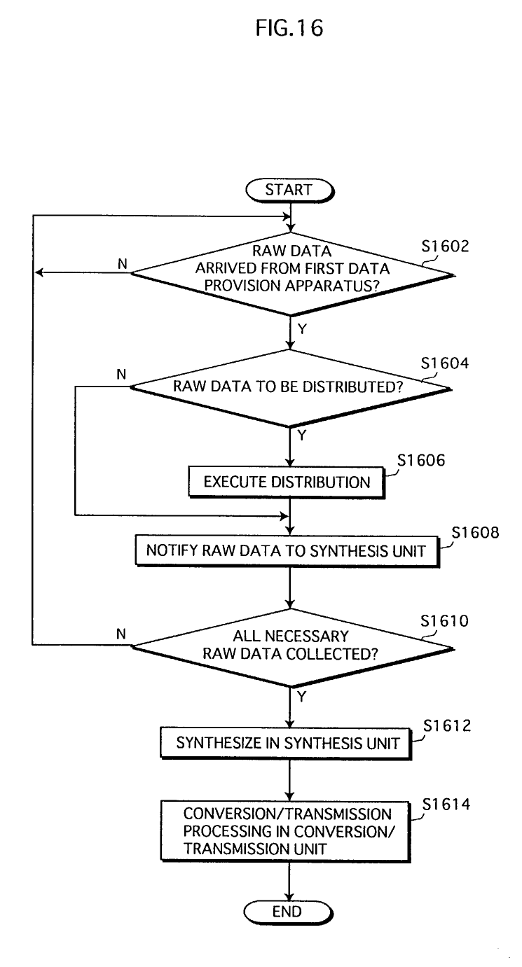

Next, operational drawings of the present embodiment are described using the flowcharts in FIG. 16 to FIG. 19.

FIG. 16 is a flowchart describing the operations of the key broadcast station data broadcast program production apparatus 101.

First, the raw data net distribution unit 114 waits for the arrival of raw data from the first data provision apparatus 121 (S1602). The raw data net distribution unit 114 refers to the net distribution setting information 701 stored in the raw data net distribution information storage unit 113 to judge whether the raw data is to be distributed to the local broadcast station data broadcast program production apparatus 102 (S1604). If the data is to be distributed, the raw data net distribution unit 114 refers to the IP address correspondence table 705, and executes distributes the raw data addressed to the IP address of the distribution target (S1606). If the raw data is not to be distributed, the raw data net distribution unit 114 notifies the synthesis unit 115 of the raw data (S1608).

On receiving notification of the raw data from the raw data net distribution unit 114, the synthesis unit 115 judges whether all the raw data shown in the second item 503 separated by the comma 501 in the synthesis instruction information 405 stored in the template storage unit 112 has been notified (S1610). If all the raw data has not been notified, the synthesis unit 115 returns to S1602. When all the raw data has been notified, the synthesis unit 115 synthesizes the data broadcast program template and the raw data (S1612), and notifies the conversion/transmission unit 116 of the synthesized data broadcast program.

The conversion/transmission unit 116 converts and then transmits the synthesized data broadcast program to the multiplexing apparatus 122 (S1614), and the processing ends.

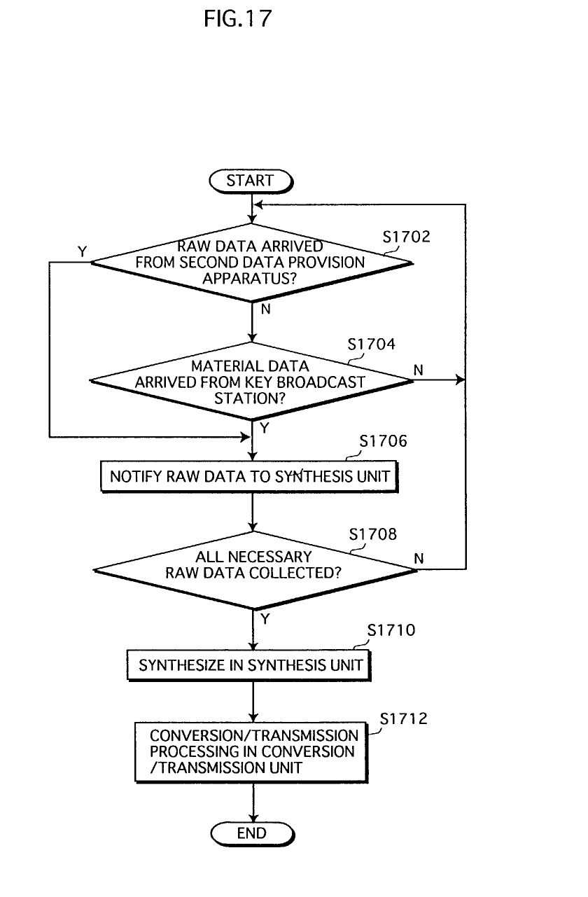

FIG. 17 is a flowchart describing the operations of the local broadcast station data broadcast program production apparatus 102.

The raw data net distribution unit 134 judges whether raw data has arrived from the second data provision apparatus 141 (S1702), and when raw data arrives, notifies the synthesis unit 135 of the raw data (S1706). If the raw data is not from the second data provision apparatus 141, the raw data net distribution unit 134 judges whether the raw data arrived from the key broadcast station data broadcast program production apparatus 101 (S1704). The raw data net distribution unit 134 returns to S1702 if the raw data did not arrive from the key broadcast station data broadcast program production apparatus 101, and proceeds to S1706 if the raw data did arrive from the key broadcast station data broadcast program production apparatus 101.

Next, the synthesis unit 135 refers to the synthesis instruction information 1204 of the program template stored in the template storage unit 132, and judges whether all the necessary raw data has been collected (S1708).

The synthesis unit 135 returns to S1702 if all has not been collected, and when all has been collected, synthesizes the program template and the raw data (S1710).

The synthesis unit 135 notifies the conversion/transmission unit 136 of the synthesized data broadcast program.

The conversion/transmission unit 136 converts and transmits the data broadcast program to the multiplexing apparatus 142 (S1712) and the processing ends.

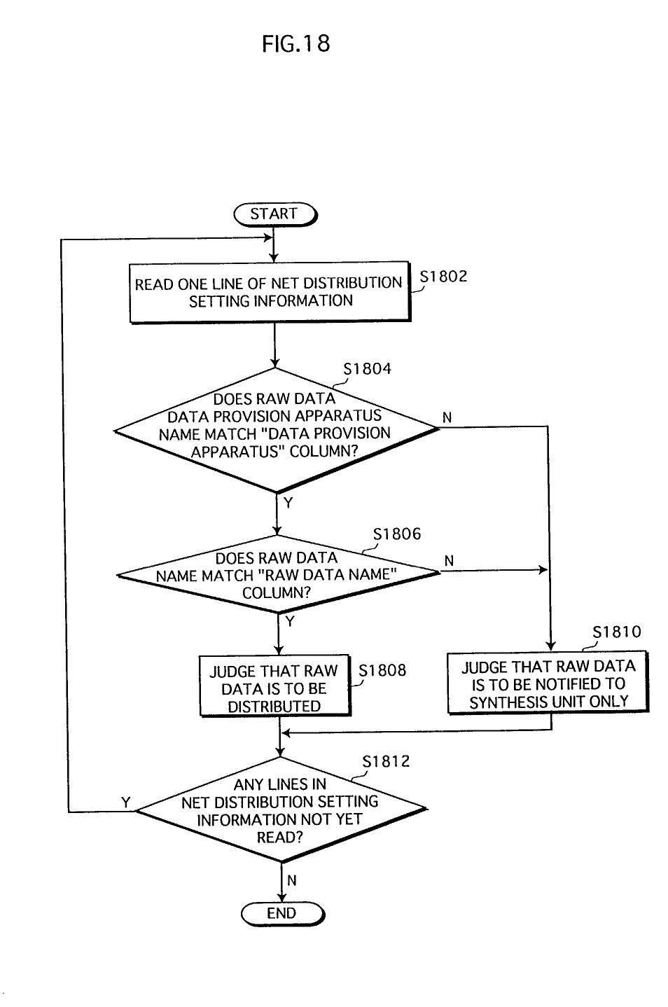

Next, the details of step S1604 in the flowchart in FIG. 16 are described with use of the flowchart in FIG. 18.

The raw data net distribution unit 114 reads one line of the net distribution setting information 801 stored in the raw data net distribution information storage unit 113 (S1802). The raw data net distribution unit 114 judges whether the name of the data provision apparatus that is the distributor of the arrived data matches the read data provision apparatus. In other words, the raw data net distribution unit 114 reads the name 806 that corresponds to the IP address 807 in the IP address correspondence table 805 from the distributor IP address, and judges whether the name and the data provision apparatus 802 in the net distribution setting information 801 match (S1804).

If the two match, the raw data net distribution unit 114 judges whether the raw data name attached to the arrived raw data and the raw data name in the net distribution setting information 801 match (S1806). If the two match, the raw data net distribution unit 114 judges that the raw data is to be distributed to the distribution target (S1808).

At S1804 and S1806, when it is judged that the two do not match, the raw data net distribution unit 114 judges to notify the raw data only the synthesis unit 115 (S1810).

Next, the raw data net distribution unit 114 judges whether there are any lines in the net distribution setting information 801 that it has not yet read (S1812), and returns to S1802 when there are, and ends the processing when there are not.

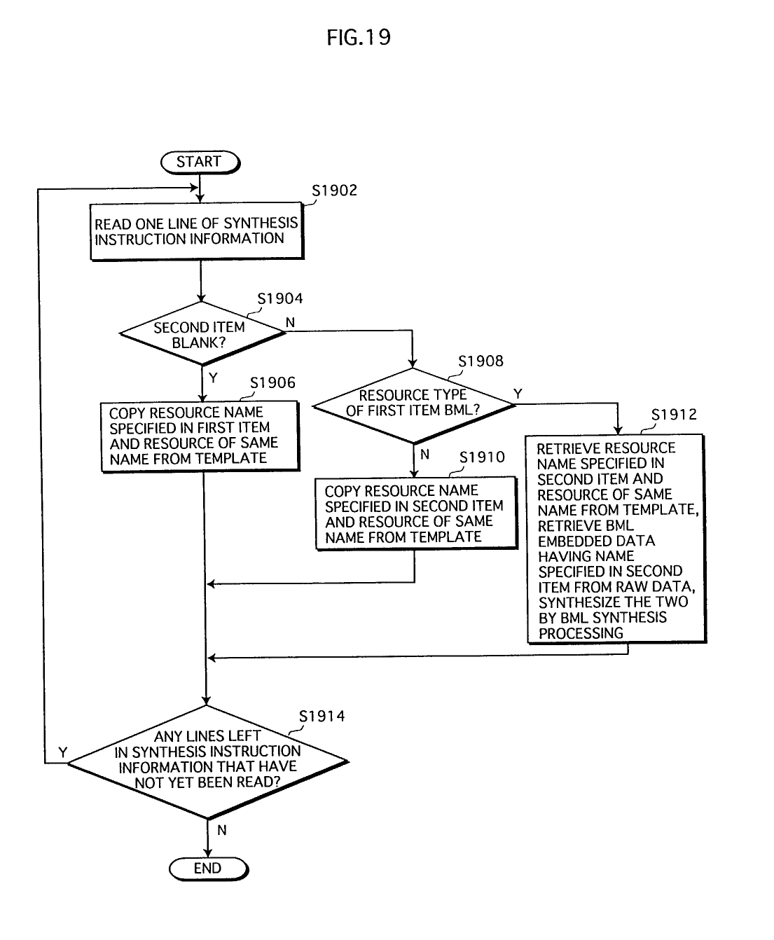

Next, details of S1612 in the flowchart in FIG. 16 are described with use of the flowchart in FIG. 19.

The synthesis unit 115 reads one line of the content of GOUSEI.TXT in the synthesis instruction information 405 of the program template stored in the template storage unit 112 (S1902), and judges whether the second item 503 is blank or not (S1904). If the second item 503 is blank, the synthesis unit 115 copies the resource name specified in the first item 52 and the resource of the same name from the program template (S1906), and proceeds to S1914.

If the second item 503 is not blank, the synthesis unit 115 judges whether the resource type of the first item is BML (document) or not (S1908), and when it is not BML, copies the resource name specified in the second item 502 and the resource of the same name from the raw data (S1910), and proceeds to S1914.

When the type of the first resource is BML, the synthesis unit 115 retrieves the resources name specified in the first item and the resource of the same name from the program template, retrieves the BML embedded data having the name specified in the second item from the raw data, and synthesizes the two according to BML synthesis processing, using the BML replacement lists 406 and 407 (S1912), and proceeds to S1914.

The synthesis unit 115 judges whether there are any lines left in the synthesis instruction information 405 that it has not read (S1914), and returns to S1902 is there are any left, and ends the processing if there are not any left.

Note that although in the present embodiment net distribution setting information is pre-stored in the raw data net distribution information storage unit 113 of the key broadcast station data broadcast program production apparatus 101, it is possible to pre-store net distribution setting information in the raw data net distribution information storage unit 133 of the local broadcast station data broadcast program production apparatus 102 and distribute raw data between the mutual data broadcast program production apparatuses 101 and 102 of the key station and the local station.

Furthermore, in the present embodiment, the local broadcast station data broadcast program production apparatus 102 produces original data broadcast program elements, however, the data broadcast program elements may be the same as those of the broadcast program elements of the key broadcast station data. In such a case, it is possible for data not to be received from the second data provision apparatus 141, but instead all raw data distributed from the key broadcast station data broadcast program production apparatus 101.

Second Embodiment

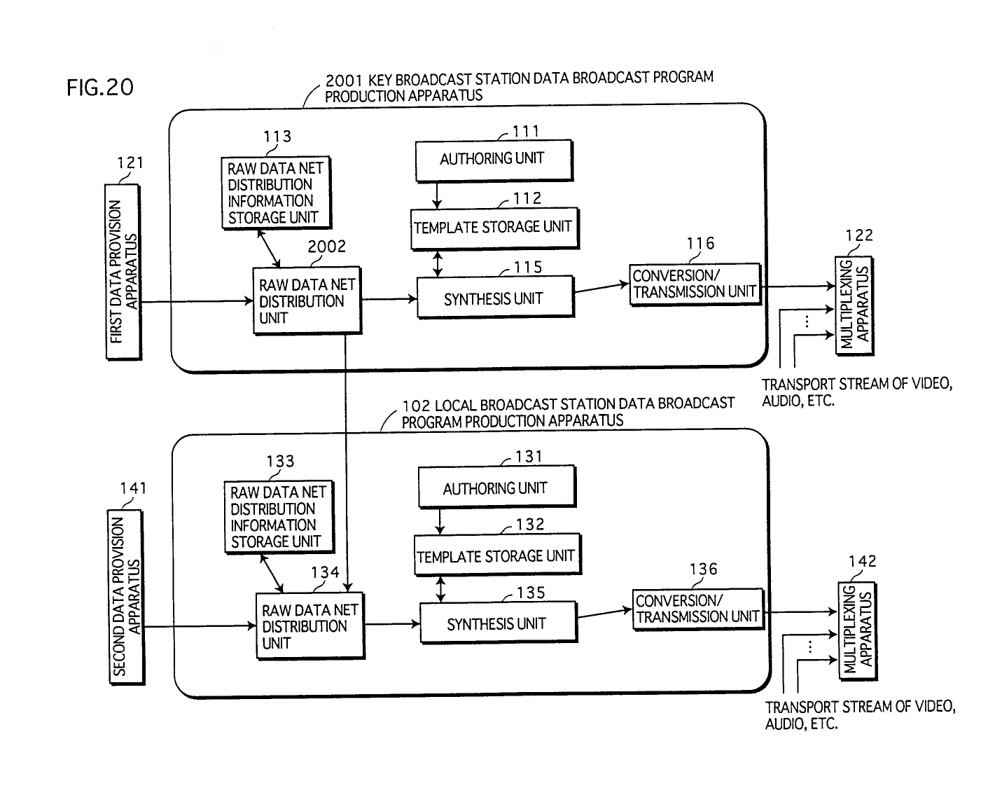

FIG. 20 is a structural drawing of a second embodiment of the data broadcast program production system of the present invention.

A key broadcast station data broadcast program production apparatus 2001 includes a raw data net distribution unit 2002 in place of the raw data net distribution unit 114 of the key broadcast station data broadcast program production apparatus 101 of the first embodiment.

In the first embodiment, the video, audio and the like multiplexed in the transport stream received by the data broadcast program the external multiplexing apparatuses 122 and 142 is weather information that is not directly related to the program. Therefore, the data broadcast program is synthesized when all the raw data has been notified to the synthesis units 115 and 135.

However, when producing a data broadcast program that corresponds to a broadcast program multiplexed in the transport stream simultaneously from the external multiplexing apparatuses 122 and 142, it is necessary to synchronize the timing of the distribution of the raw data with the broadcast program.

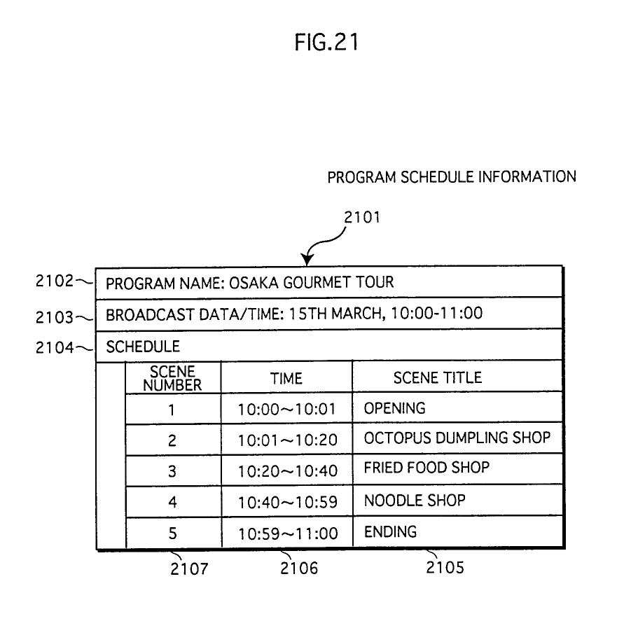

Accordingly, the raw data net distribution unit 2002 obtains and stores program schedule information such as that shown in FIG. 21, from a program compilation unit, which is not illustrated. A program name 2102, a broadcast date/time 2103, and a schedule 2104 of the broadcast program are shown in program schedule information 2101.

A broadcast time 2106 and a scene number 2107 that corresponds to a scene title 2105 of each scene in the program is listed in a schedule 2104.

A data broadcast program that corresponds to the scenes of the program is produced by the key broadcast station data broadcast program production apparatus 2001.

Therefore, raw data having a scene number that corresponds to the raw data is transmitted from first data provision apparatus 121 to the raw data net distribution unit.

For example, when the local broadcast station data broadcast program production apparatus 102 is listed as the distribution target for raw data “NOODLE SHOP” in the net distribution setting information in the raw data net distribution information storage unit 113, even if raw data relating to “noodle shop”, which has a scene number 4, arrives at the raw data net distribution unit 2002, the raw data net distribution unit 2002 does not distribute the raw data to the synthesis unit 115 and the raw data net distribution unit 134 of the local broadcast station data broadcast program production apparatus 102 until 10:40, which is the time that corresponds to the scene number 4.

In this way, a data broadcast program can be produced corresponding to each scene of a broadcast program.

Third Embodiment

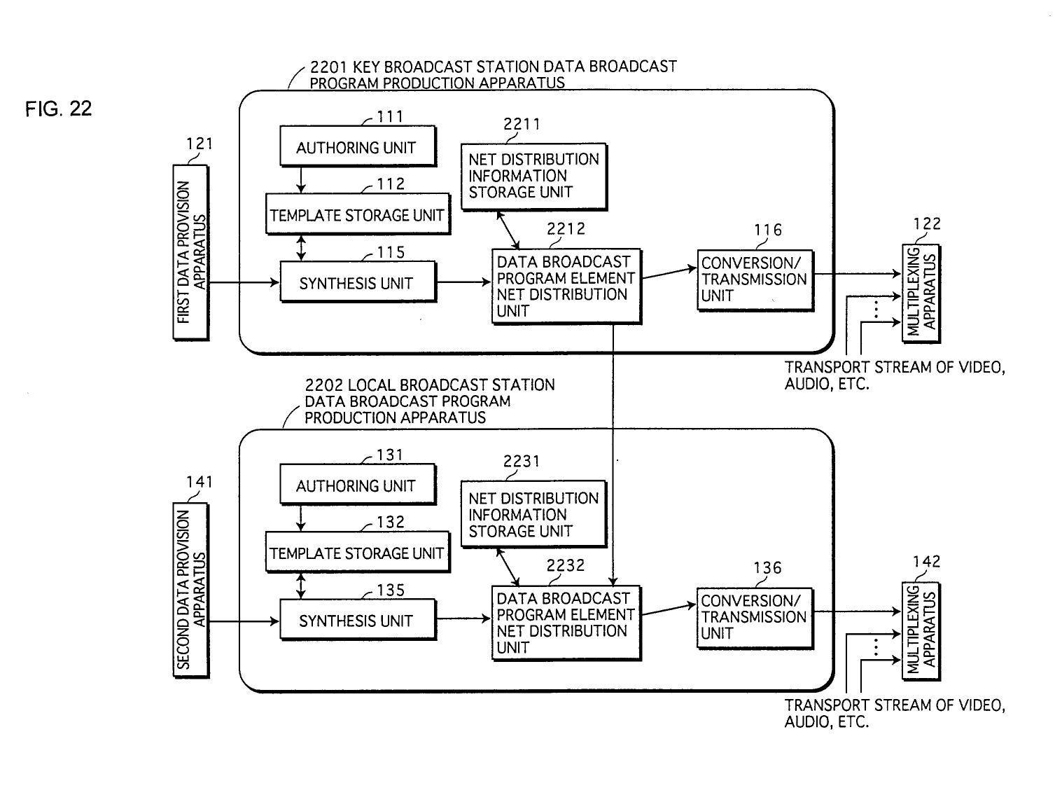

FIG. 22 is a structural drawing of the third embodiment of the data broadcast program production system of the present invention.

The data broadcast program production system is composed of a key broadcast station data broadcast program production apparatus 2201 and a local broadcast station data broadcast program production apparatus 2202.

The data broadcast program production apparatus 2201 includes the authoring unit 111, the template storage unit 112, the synthesis unit 115, a net distribution information storage unit 2211, a data broadcast program element net distribution unit 2212, and the conversion/transmission unit 116.

The data broadcast program production apparatus 2202 includes the authoring unit 131, the template storage unit 132, the synthesis unit 135, a net distribution information storage unit 2231, a data broadcast program element net distribution unit 2232, and the conversion/transmission unit 136.

Note that the constituent features that are substantially the same as those in the first embodiment have the same number as those in the first embodiment, thus a description thereof is omitted. The following describes the constituent features that are unique to the present embodiment.

In the first embodiment, the synthesis unit 115 receives notification of the raw data from the raw data net distribution unit 114 and notifies the conversion/transmission unit 116 of the synthesized data broadcast program elements. However, in the present embodiment, the synthesis unit 115 receives the raw data directly from the first data provision apparatus 121, and notifies the data broadcast program element net distribution unit 2212 of the synthesized data broadcast program element. Note that the notified raw data is the same as that in the first embodiment.

The net distribution information storage unit 2211 stores in advance, from among the synthesized data broadcast program elements, data broadcast program elements to be distributed and the distribution targets thereof.

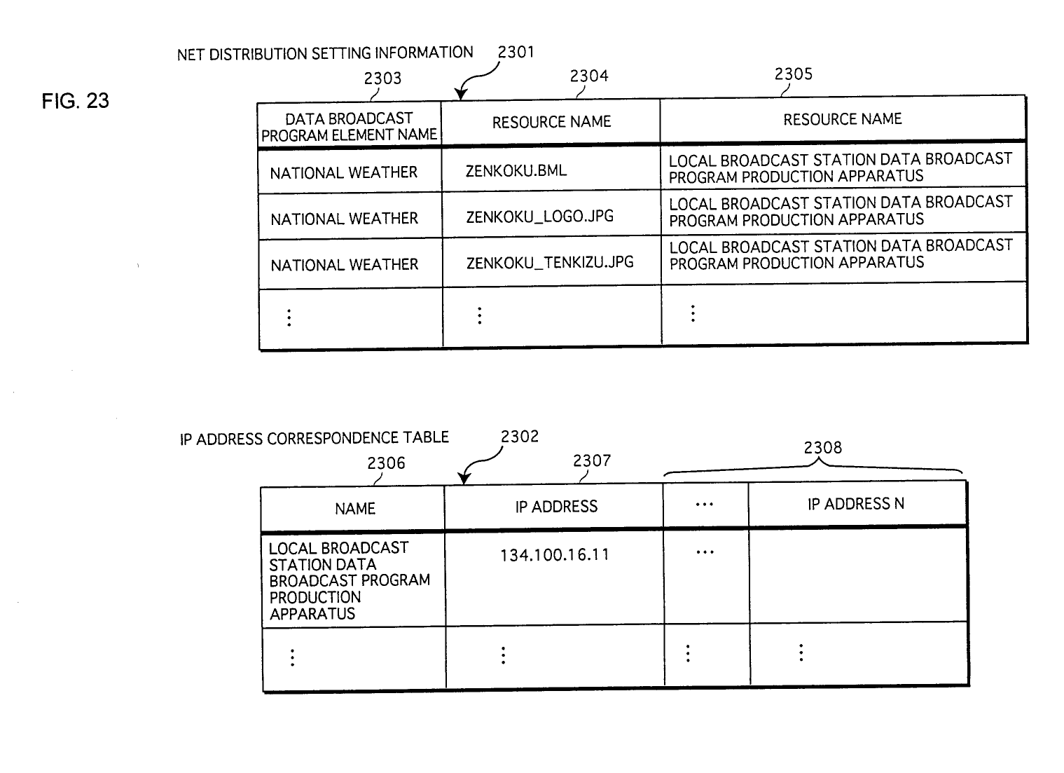

FIG. 23 is net distribution setting information and an IP address correspondence table stored in the net distribution information storage unit 2211.

A data broadcast program element name 2303, a resource name 2303, and a distribution target 2305 are listed in the net distribution setting information 2301 for each resource.

A distribution target name 2306 and a corresponding IP address 2307 are listed in the IP address correspondence table 2303. If a plurality of distribution targets are to be distributed to, corresponding IP addresses 2308 can be listed.

Resources 401 to 404, synthesis instruction information 405, and BML replacement list 406 and 407 that compose a program template are listed in the template storage unit 112, in the same manner as in the first embodiment.

On receiving notification of the synthesized data broadcast program element form the synthesis unit 115, the data broadcast program element net distribution unit 2212 judges whether the data broadcast program element name listed in the net distribution setting information and the resource name match, and when the two match, distributes the data broadcast program element addressed to the IP address of the distribution target that corresponds to the IP address correspondence table 2302. Specifically, the data broadcast program element 1004 shown in FIG. 10 is distributed.

The data broadcast program element 1004 is distributed to the data broadcast program element net distribution unit 2232 of the local broadcast station data broadcast program production apparatus 2202 from the key broadcast station data broadcast program production apparatus 2201.

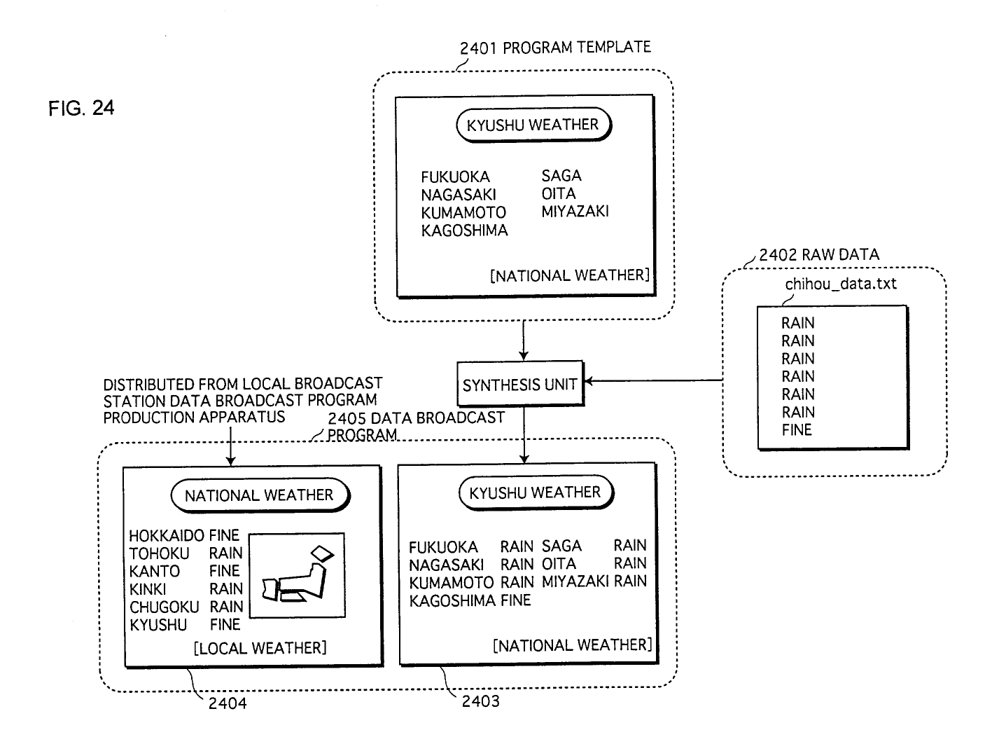

FIG. 24 shows an outline of production of a data broadcast program by the data broadcast program production apparatus 2202 visually. A data broadcast program element “NATIONAL WEATHER” 2404 (1004) that makes up a data broadcast program 2405 is distributed from the key broadcast station data broadcast program production apparatus 2201 to the data broadcast program element net distribution unit 2232.

Note that since net distribution setting information and an IP address correspondence table are not stored in the net distribution information storage unit 2231, a data broadcast program element is not distributed from the data broadcast program production apparatus 2202 to other data broadcast program production apparatuses. However, by storing net distribution setting information and an IP address correspondence table in the net distribution information storage unit 2231, it is possible to distribute data broadcast program elements synthesized by the data broadcast program production apparatus 2202 to other data broadcast program production apparatuses.

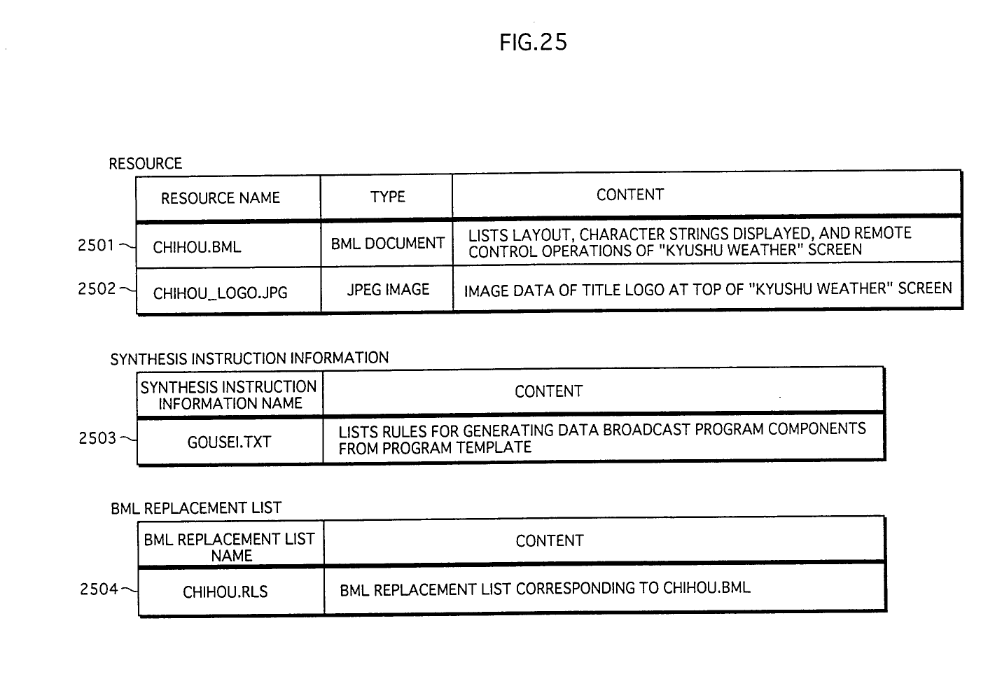

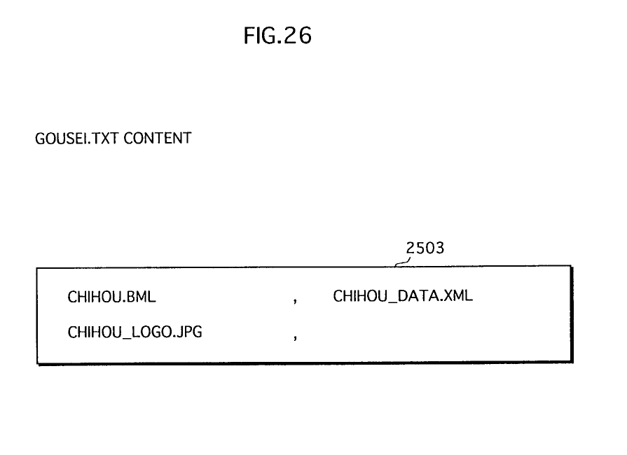

FIG. 25 shows an outline of resources 2501 and 2502, synthesis instruction information 2503, and a BML replacement list 2504 that compose a program template 2401 that is stored in the template storage unit 132. Details of the BML replacement list 2504 are shown in FIG. 26. Details of the BML replacement list 2504 are the same as those for the replacement list 1206 in FIG. 14.

The synthesis unit 135 receives raw data 2402 (raw data 1103 shown in FIG. 15) from the second data provision apparatus 141.

The synthesis unit 135 synthesizes a data broadcast program element “KYUSHU WEATHER” 2403 from the program template 2401 stored in the template storage unit 132 and the raw data 2402.

Note that for the operations of the key broadcast station data broadcast program production apparatus 2201 of the present embodiment, S1604 “DATA TO BE DISTRIBUTED?” in FIG. 16 is changed to “DATA BROADCAST PROGRAM ELEMENT TO BE DISTRIBUTED”, and S1604 and S1606 are moved to be after S1612. Furthermore, for the operations of the local broadcast station data broadcast program production apparatus 2202, S1704 in the flowchart shown in FIG. 17 is omitted, and S1702 returned to when “NO” at S1702. Furthermore, a step of waiting for a broadcast program element to be distributed from the key station is inserted after S1710.

Furthermore, in the flowchart in FIG. 18 it is the data broadcast program element net distribution unit 2212 that performs the operations, not the raw data net distribution unit 114. S1804 “DOES RAW DATA DATA PROVISION APPARATUS NAME MATCH “DATA PROVISION APPARATUS” COLUMN?” is changed to “DOES DATA BROADCAST PROVISION PROGRAM ELEMENT NAME OF DATA BROADCAST PROGRAM ELEMENT MATCH “DATA BROADCAST PROGRAM ELEMENT” NAME?”, at S1806 “RAW DATA NAME” is changed to “RESOURCE NAME”, and at S1808 “JUDGE THAT RAW DATA IS TO BE DISTRIBUTED” is changed to “JUDGE THAT DATA BROADCAST PROGRAM ELEMENT IS TO BE DISTRIBUTED”. Furthermore, S1810 is changed so that the data broadcast program element is notified only to the conversion/transmission unit.

Fourth Embodiment

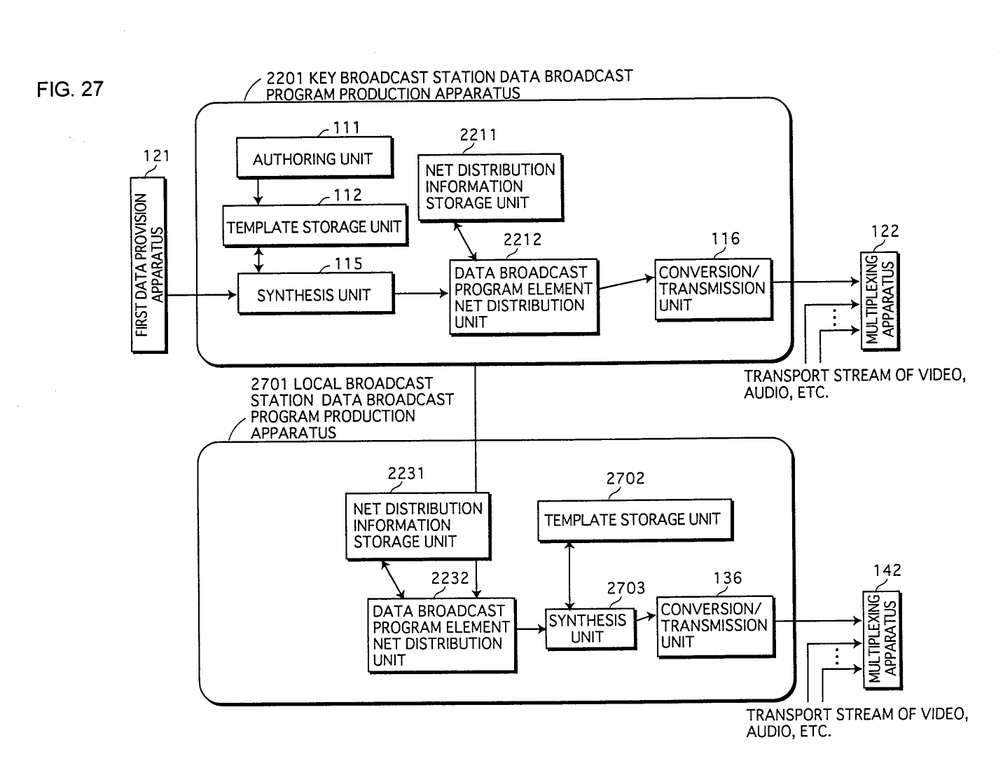

FIG. 27 is a structural drawing of the fourth embodiment of the data broadcast program production system of the present invention.

The data broadcast program production system is composed of the key broadcast station data broadcast program production apparatus 2201 and a local broadcast station data broadcast program production apparatus 2701.

The key broadcast station data broadcast program production apparatus 2201 is the same as the data broadcast production apparatus of the third embodiment.

The local broadcast station data broadcast program production apparatus 2701 includes the net distribution information storage unit 2231, the data broadcast program element net distribution unit 2232, the conversion/transmission unit 136, a template storage unit 2702, and a synthesis unit 2703.

Note that the constituent elements that are substantially the same as those in the first embodiment have the same numbering, and a description thereof is omitted. The following describes the constituent elements unique to the present embodiment.

The data broadcast program production apparatus 2701 produces data broadcast programs using data broadcast program elements synthesized by the key broadcast station data broadcast program production apparatus 2201.

The synthesis unit 2703 receives notification of data broadcast program elements from the data broadcast program element net distribution unit 2212 via the data broadcast program element net distribution unit 2232.

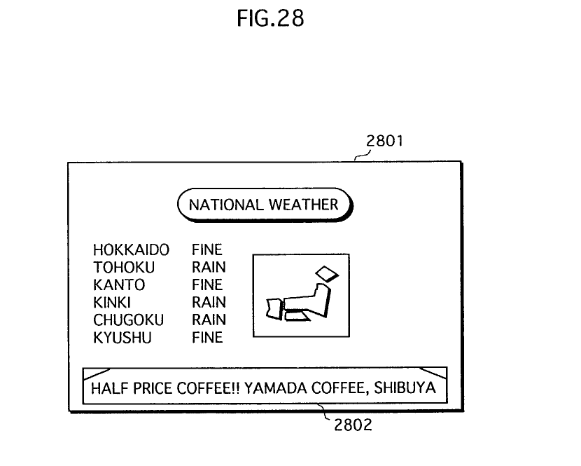

For example, the synthesis unit 2703 receives notification of the data broadcast program element “NATIONAL WEATHER” 2801 shown in FIG. 28.

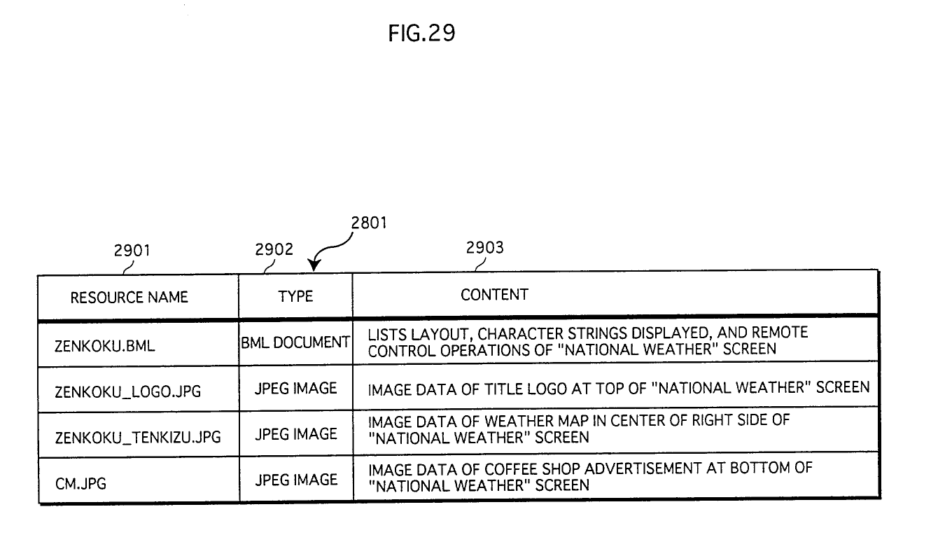

The resources that compose the data broadcast program element “NATIONAL WEATHER” 2801 are shown in FIG. 29. Each resource in the resources 2801 is identified by resource name 2901, and shows a type 2902 and data content 2903.

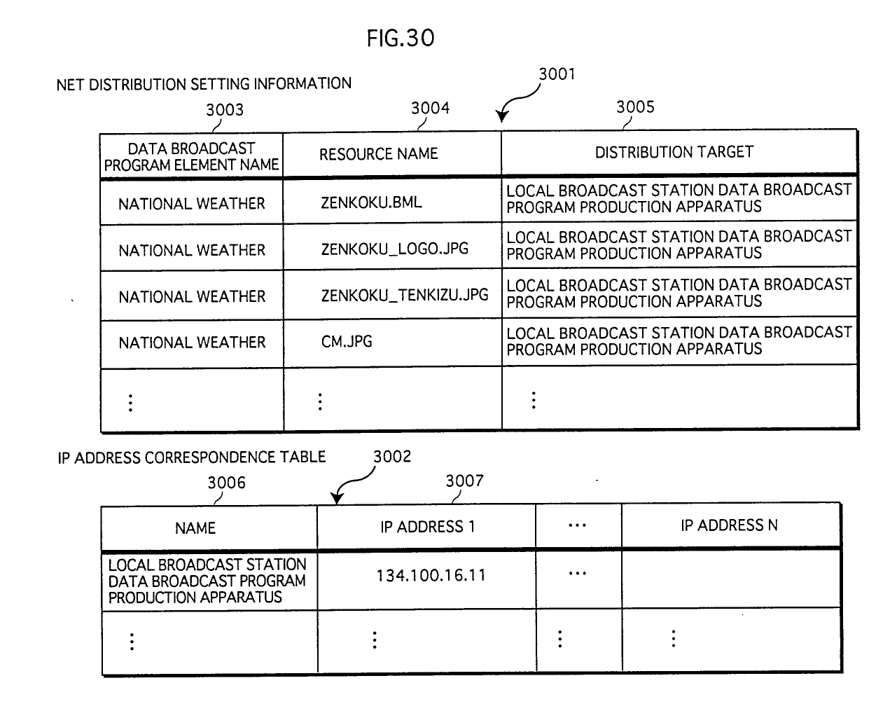

Note that net distribution setting information 3001 and an IP address correspondence table 3002 shown in FIG. 30 are stored in the net distribution information storage unit 2211 of the key broadcast station data broadcast program production apparatus 2201.

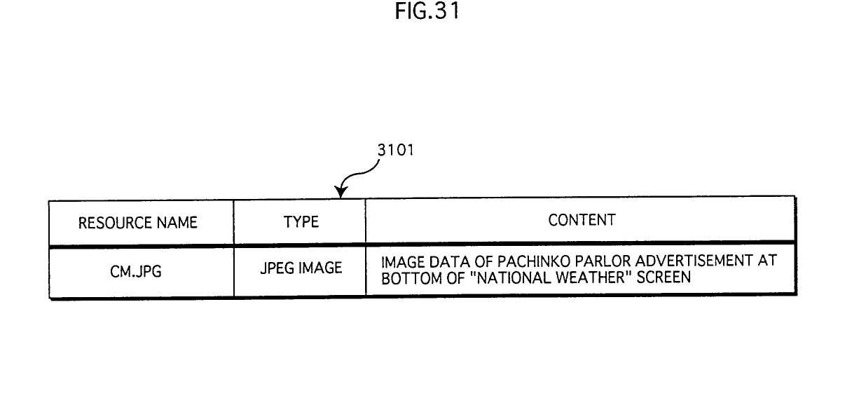

FIG. 31 shows as example of raw data that the synthesis unit 2703 has obtained from the authoring unit (not illustrated).

The template storage unit 2702 stores a unique program template.

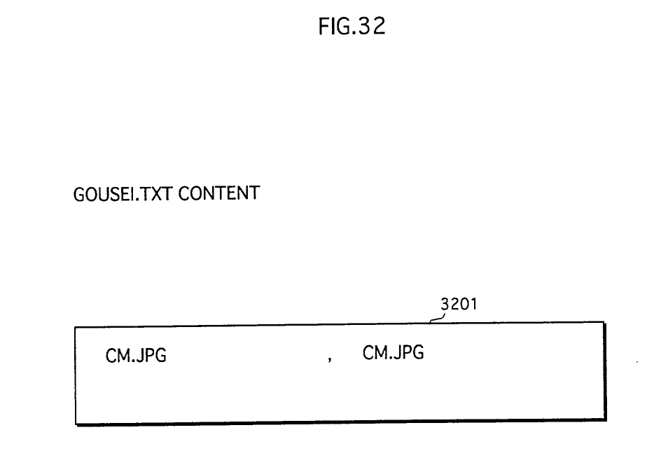

FIG. 32 is the program template stored in the template storage unit 2702. This program template is composed of synthesis instruction information 3201.

The synthesis unit 2703 synthesizes the data broadcast program element 2801 and the raw data 3101 in accordance with the synthesis instruction information 3201.

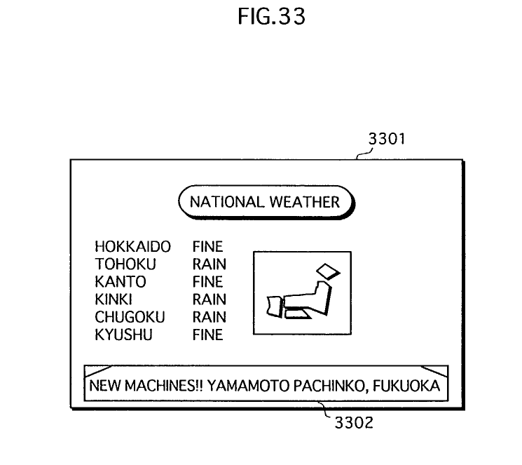

FIG. 33 shows the unique data broadcast program element synthesized by the synthesis unit. At the bottom of the screen below the data broadcast program element “NATIONAL WEATHER” 3301, an advertisement 3302 for a pachinko parlor is displayed instead of the advertisement 2802 for the coffee shop in national weather 2801.

Fifth Embodiment

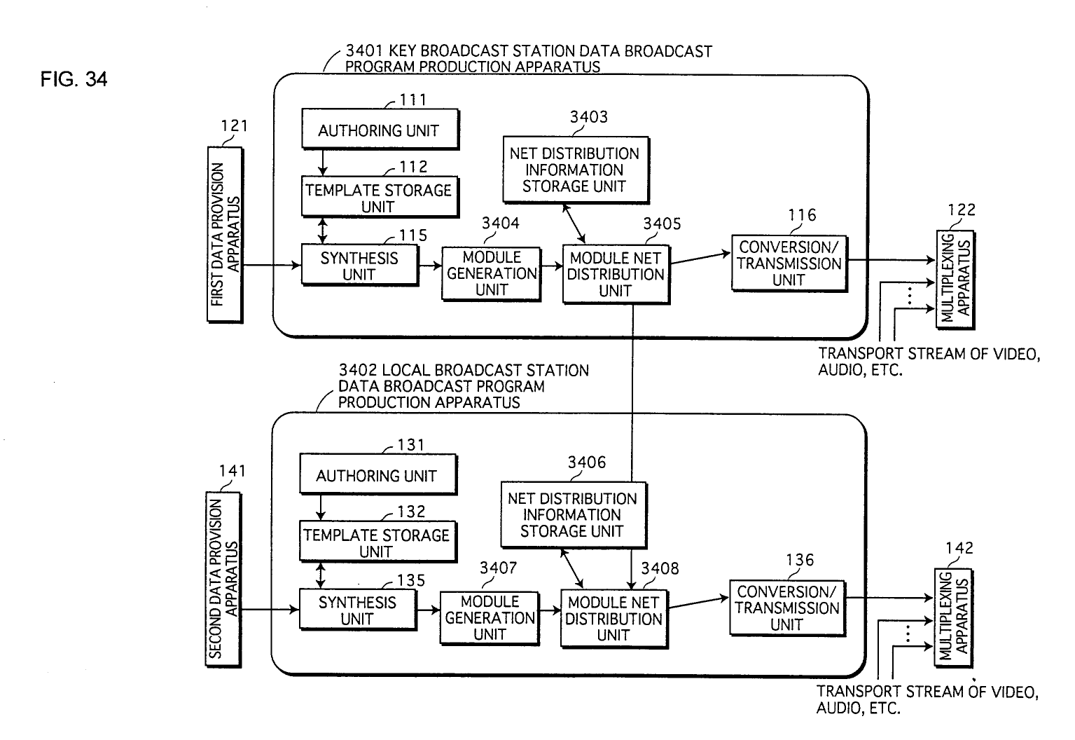

FIG. 34 is a structural drawing of the fifth embodiment of the data broadcast program production system of the present invention.

When the description method of the data broadcast program follows the ARIB standard, as shown in FIG. 34, it is possible to distribute modules between broadcast stations by making the module generation units 3404 and 3407 for exchanging the resources that compose the data broadcast program elements generated by the synthesis units 115 and 135 independent, having module net distribution units 3405 and 3408 at a later stage, and having modules distributed between broadcast stations.

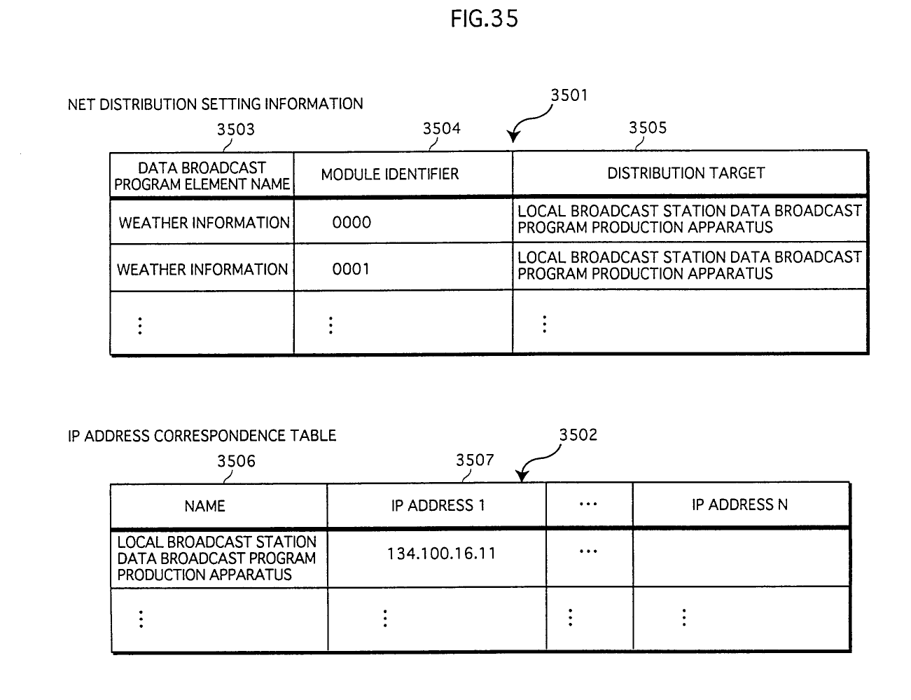

In this case, the net distribution setting information that specifies the operations of the module net distribution unit 3405 is stored in the net distribution information units 3403 and 3406, and as shown in FIG. 35, distribution is performed according to specification of the module identifier.

The module net distribution unit 3405, when the data broadcast program name and the module identifier of a module notified from the module generation unit 3404 match any of the lines in the data broadcast program name 3503 column and the module identifier 3504 column respectively in the net distribution setting information 3501, judges that the module is to be distributed to the distribution target in the corresponding line in the distribution target 3505 in the net distribution setting information. The module net distribution unit 3405 distributes the module to the IP address 3507 corresponding to the name of the distribution target in the IP address in the IP address correspondence table 3502.

Sixth Embodiment

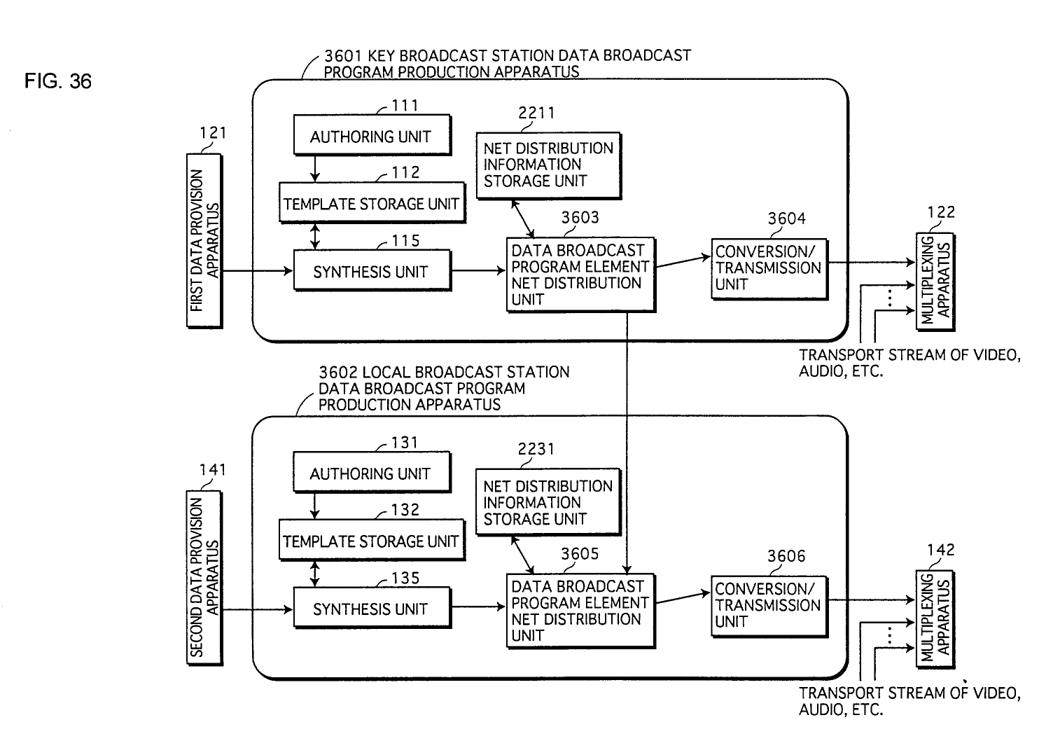

FIG. 36 is a structural drawing of the sixth embodiment of the data broadcast program production system of the present invention.

The data broadcast program production system is composed of a key broadcast station data broadcast program production apparatus 3601 and a local broadcast station data broadcast program production apparatus 3602.

The data broadcast program production apparatus 3601 includes the authoring unit 111, the template storage unit 112, the synthesis unit 115, a net distribution information storage unit 2211, a data broadcast program element net distribution unit 3603, and a conversion/transmission unit 3604.

The data broadcast program production apparatus 3602 is composed the authoring unit 131, and the template storage unit 132, the synthesis unit 135, and the net distribution information storage unit 2231, a data broadcast program element net distribution unit 3605, and a conversion/transmission 3606.

Note that the constituent elements that are substantially the same as those in the third embodiment have the same numbering, and a description thereof is omitted. The following describes the constituent elements unique to the present embodiment.

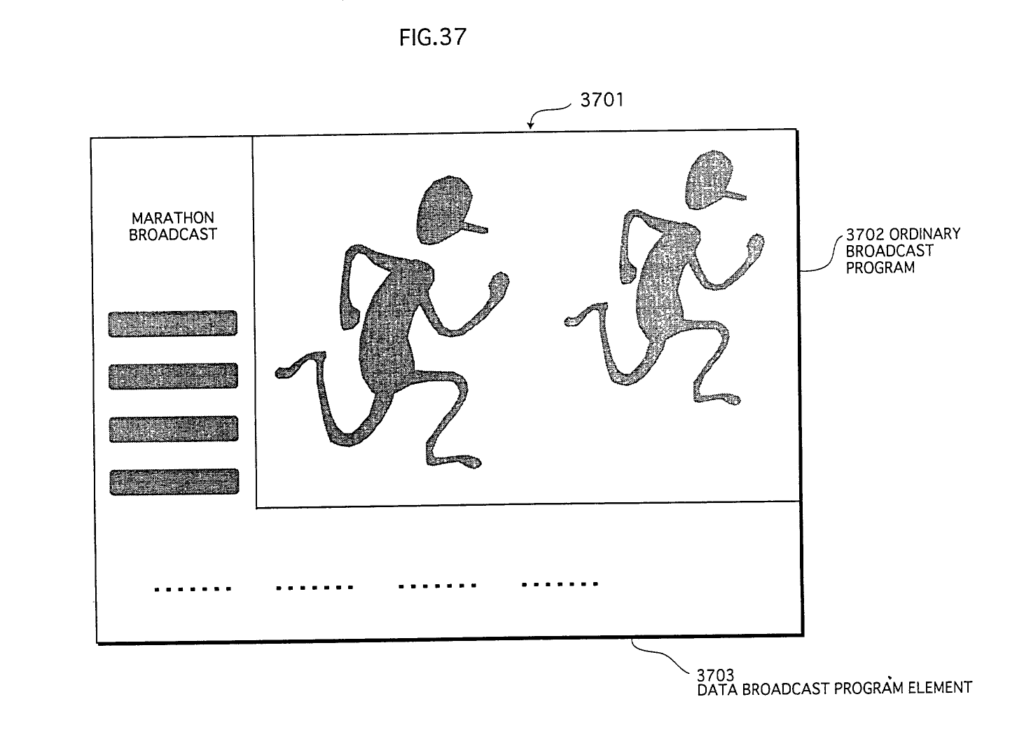

In the third embodiment, the data broadcast program is weather information that has no relation to the ordinary broadcast program. However, there are cases in which a data broadcast program that is related to the ordinary program is output to the screen simultaneously with the ordinary program, as shown in FIG. 37. For example, a live broadcast of a sporting event 3702 and a data broadcast program 3703 related to the sporting event may be displayed on a screen 3701.

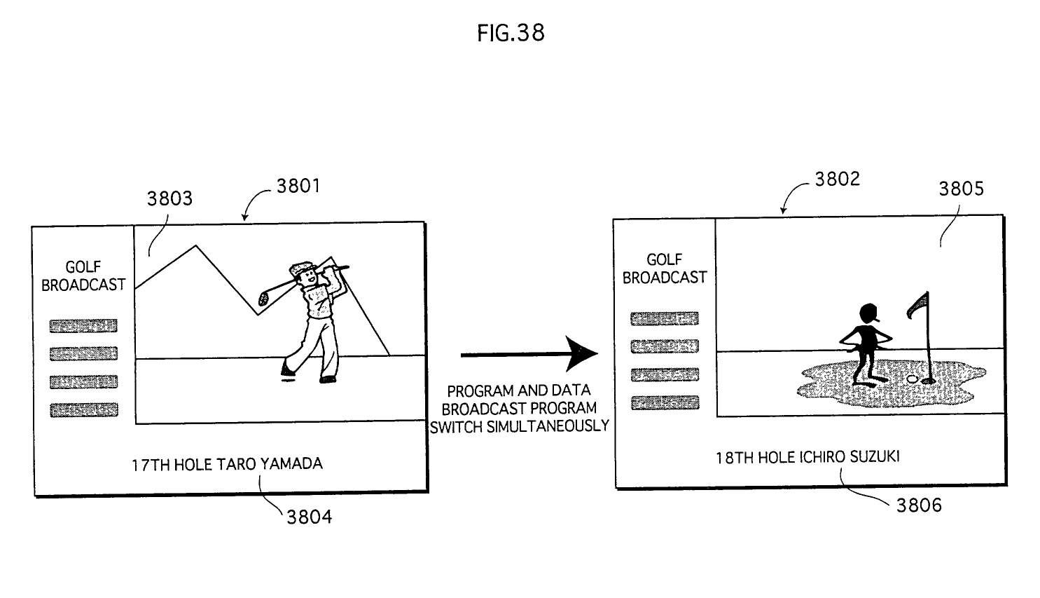

In such a case, it is desirable to realize a screen 3801 and a screen 3802 in which the timing of a switch from the broadcast program scene 3803 to the broadcast program scene 3805 is synchronized with a switch from a broadcast program element 3804 to a broadcast program element 3806, as shown in FIG. 38.

For this purpose, the data broadcast program element net distribution unit 3603 records a time stamp, which is a time required for distributing the data broadcast program element to the local broadcast station data broadcast program production apparatus 3602 added to the current time, in the data broadcast program element that is distributed and in the its own conversion/transmission unit 3604. The conversion/transmission unit 3604 sends the data broadcast program element to the external multiplexing apparatus 122 in accordance with the time stamp.

Similarly, the conversion/transmission unit 3606 of the local broadcast station data broadcast program production apparatus 3602 sends the data broadcast program element notified from the data broadcast program element net distribution unit 3603 via the data broadcast program element net distribution unit 3605 to the external multiplexing apparatus 122 according to the time stamp.

Accordingly, the timing of the data broadcast element sent to the external multiplexing apparatuses 122 and 142 is the same at the key broadcast station and the local broadcast station.

Seventh Embodiment

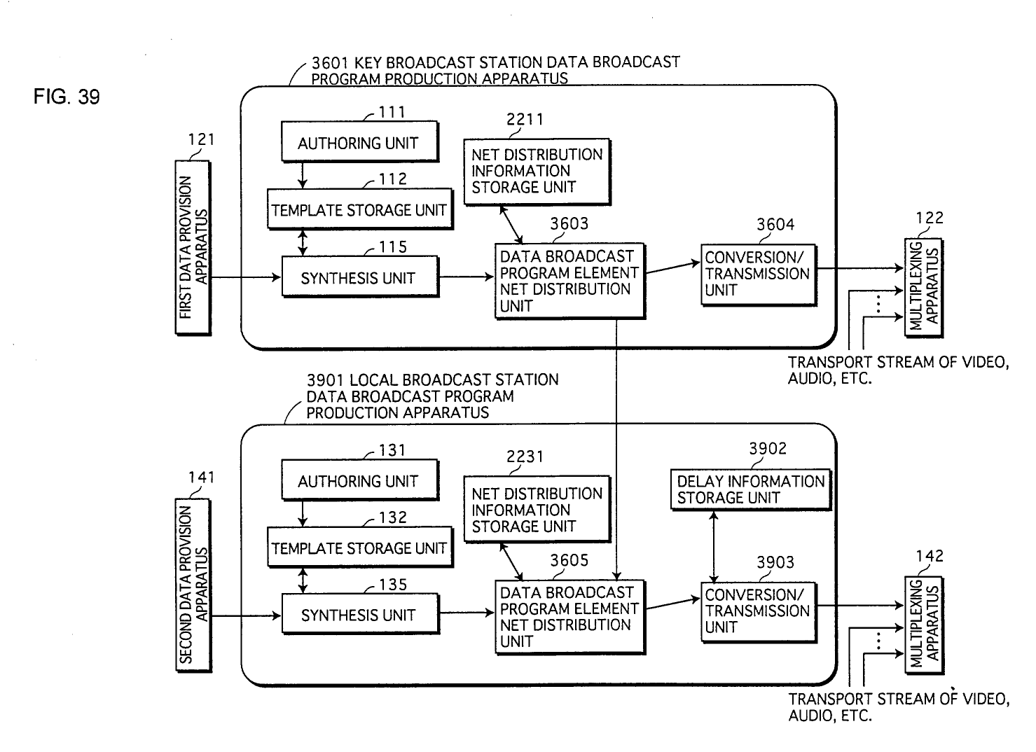

FIG. 39 is a structural drawing of a seventh embodiment of the data broadcast program production system of the present invention.

The data broadcast program production system is composed of the key broadcast station data broadcast program production apparatus 3601 and a local broadcast station data broadcast program production apparatus 3901.

The data broadcast program production apparatus 3601 includes the authoring unit 111, the template storage unit 112, the synthesis unit 115, the net distribution information storage unit 2211, the data broadcast program element net distribution unit 3603, and a conversion/transmission unit 3604.

The data broadcast program production apparatus 3901 is composed of the authoring unit 131, the template storage unit 132, the synthesis unit 135, the net distribution information storage unit 2231, the data broadcast program element net distribution unit 3605, a delay information storage unit 3902, and a conversion/transmission unit 3903.

Note that the constituent elements that are substantially the same as those in the sixth embodiment have the same numbering, and a description thereof is omitted. The following describes the constituent elements unique to the present embodiment.

In the sixth embodiment the absolute time at which the data broadcast program elements are sent in the key broadcast station and the local broadcast station to the external multiplexing apparatuses 122 and 142 matches. However, in reality there are cases in which the timing of switching from one scene to another does not match in the key broadcast station and the local broadcast station.

Generally, a switch from one scene to another scene occurs later at the local broadcast station that the key broadcast station because of a lag in transmission of the broadcast program. In such a case, if the switch timing of the data broadcast program element at the local broadcast station is not delayed for the same time, it will not match the switch timing of the scene.

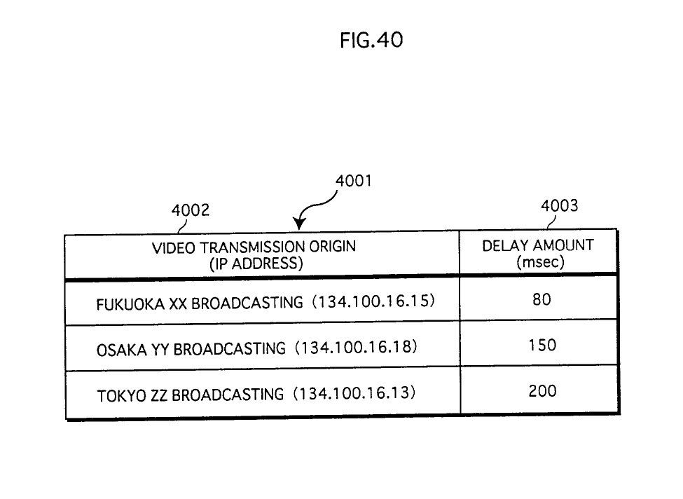

For this reason, the local broadcast station data broadcast program production apparatus stores delay information 4001 shown in FIG. 40 in the delay information storage unit 3902.

A set of a broadcast program (video) transmission origin 4002 and a delay amount 4003 are listed in the delay information 4001.

For example, when the local broadcast station is in Kagoshima, 150 msecs are required to transmit a broadcast program from Osaka YY Broadcasting, and 200 msecs are required to transmit a broadcast program from Tokyo ZZ Broadcasting. Therefore, the conversion/transmission unit 3903 transmits the data broadcast program element to the multiplexing apparatus with a delay equal to the delay amount, in relation to the time stamp in the data broadcast program element explained in the sixth embodiment. Accordingly, the switch from one scene to another in the broadcast program and the switch from one data broadcast program element to another are synchronized.

Note that the various embodiments of the as shown in the structural drawings in FIGS. 1, 20, 22, 27, 34, 36, and 39, but the various components may be implemented as a computer program that realizes the functions of the various components. This computer program may be recorded on a computer-readable recording medium and applied to a data broadcast program production system.

### INDUSTRIAL USE

The present invention provides a data broadcast program production system that in digital broadcasting is capable of effectively performing distribution of raw data and distribution of data broadcast program elements mutually between TV broadcast stations that produce data broadcast programs.

1. A data broadcast program production system that includes a first broadcast station data broadcast program production apparatus and a second broadcast station data broadcast program production apparatus, the first broadcast station data broadcast program production apparatus comprising:
distribution information storage means for storing distribution information in which at least one raw data identifier and a raw data distribution target are corresponded; and
raw data distribution means for, when raw data is received from an external raw data provision device, selecting a piece of raw data whose identifier is in the distribution information, and distributing the selected piece of raw data to the second broadcast station data broadcast program production apparatus, the second broadcast station data broadcast program production apparatus being the corresponded raw data distribution target.

2. The data broadcast program production system of claim 1, wherein
the first broadcast station data broadcast program production apparatus further comprises:
first template storage means for storing a first template for a data broadcast program; and
first synthesis means for receiving notification of both the selected piece of raw data and one or more pieces of raw data that were not selected by the distribution means, and synthesizing the notified pieces of raw data, using the first template, to produce a data broadcast program element that composes a data broadcast program, and
the second broadcast station data broadcast program production apparatus comprises:
second template storage means for storing a second template for a data broadcast program; and
second synthesis means for receiving at least one piece of raw data from another external raw data provision apparatus and receiving the piece of raw data distributed from the first broadcast station data broadcast production apparatus, and synthesizing the received pieces of raw data, using the second template, to produce a data broadcast program element that composes a data broadcast program.

3. The data broadcast program production system of claim 1, wherein
the first broadcast station data broadcast program production apparatus further comprises:
program schedule storage means for storing a program schedule that lists a broadcast time for each scene of a broadcast program that is broadcast simultaneously with a data broadcast program, each scene having a scene identifier,
each piece of raw data has a scene identifier that corresponds to a scene, and
the raw data distribution means distributes the selected piece of raw data in accordance with the broadcast time of the scene of the broadcast program corresponding to the scene identifier of the raw data.

4. A data broadcast program production system that includes a first broadcast station data broadcast program production apparatus and a second broadcast station data broadcast program production apparatus, the first broadcast station data broadcast program production apparatus comprising:
template storage means for storing a template for a data broadcast program;
synthesis means for, on receiving raw data, synthesizing the received raw data, using the template, to produce a data broadcast program element that composes a data broadcast program, and appending an identifier to the data broadcast program element;
distribution information storage means for storing distribution information in which at least one data broadcast program element identifier and a data broadcast program element distribution target are corresponded; and
data broadcast program element distribution means for, on receiving notification of at least one produced data broadcast program element from the synthesis means, selecting a data broadcast program element whose identifier is shown in the distribution information, and distributing the selected data broadcast program element to the second broadcast station data broadcast program production apparatus, the second broadcast station data broadcast program production apparatus corresponding to the distribution target.

5. The data broadcast program production system of claim 4, wherein the second broadcast station data broadcast program production apparatus comprises:
reception means for receiving the data broadcast program element distributed from the first broadcast station data broadcast program production apparatus;
unique template storage means for storing a unique template used to generate a unique data broadcast program element from the received data broadcast program element; and
synthesis means for synthesizing a unique data broadcast program element from the received data broadcast program element, using the unique template.

6. The data broadcast program production system of claim 4, wherein
the first broadcast station data broadcast program production apparatus further comprises:
conversion/transmission means for receiving notification of a data broadcast program element from the data broadcast program element distribution means, converting the data broadcast program element to a transport stream, and transmitting the transport stream, wherein
the data broadcast program element distribution means appends a time stamp to the data broadcast program element, the time stamp being a time that is the amount of required for distribution of the data broadcast program element to the second broadcast station broadcast program production apparatus added to a current time, and
the conversion/transmission means transmits the transport stream in compliance with the time stamp; and
the second broadcast station broadcast program production apparatus further comprising:
conversion means for, in compliance with the time stamp, converting the received data broadcast program element to a transport stream and transmitting the transport stream.

7. The data broadcast program production system of claim 6, wherein
the second broadcast station data broadcast program production apparatus further comprises:
delay information storage means for storing delay information that shows an amount of time required for distribution of a broadcast program from the first broadcast station, and
the conversion means delays transmission of the transport stream by the amount of time shown in the delay information.

8. A data broadcast program production system that includes a first broadcast station data broadcast program production apparatus and a second broadcast station data broadcast program production apparatus, the first broadcast station data broadcast program production apparatus comprising:
template storage means for storing a template for a data broadcast program;
module synthesis means for, on receiving raw data, synthesizing the raw data, using the template, to produce a module that composes a data broadcast program, and appending a module identifier to the module;
distribution information storage means for storing distribution information in which at least one module identifier and a distribution target are corresponded; and
module distribution means for, on receiving notification of one or more synthesized modules from the module synthesis means, selecting a module shown by the module identifier in the distribution information, and distributing to the second broadcast station data broadcast program production apparatus that corresponds to the distribution target.

9. A data broadcast program production method for a first broadcast station and a second broadcast station, the method including at the first broadcast station:
a distribution information storage step for storing distribution information in which at least one raw data identifier and a raw data distribution target are corresponded; and
a raw data distribution step for, when raw data is received from an external raw data provision device, selecting a piece of raw data whose identifier is in the distribution information, and distributing the selected piece of raw data to the second broadcast station data broadcast program production apparatus, the second broadcast station data broadcast program production apparatus being the corresponded raw data distribution target.

10. A data broadcast program production method for a first broadcast station and a second broadcast station, the method including at the first broadcast station:
a template storage step for storing a template for a data broadcast program;
a synthesis step for, on receiving raw data, synthesizing the received raw data, using the template, to produce a data broadcast program element that composes a data broadcast program, and appending an identifier to the data broadcast program element;
a distribution information storage step for storing distribution information in which at least one data broadcast program element identifier and a data broadcast program element distribution target are corresponded; and
a data broadcast program element distribution step for, on receiving notification of at least one produced data broadcast program element at the synthesis step, selecting a data broadcast program element whose identifier is shown in the distribution information, and distributing the selected data broadcast program element to the second broadcast station data broadcast program production apparatus, the second broadcast station data broadcast program production apparatus corresponding to the distribution target.

11. A computer program that executes on a computer a data broadcast program production method for a first broadcast station and a second broadcast station, the method including at the first broadcast station:
a template storage step for storing a template for a data broadcast program;
a synthesis step for, on receiving raw data, synthesizing the received raw data, using the template, to produce a data broadcast program element that composes a data broadcast program, and appending an identifier to the data broadcast program element;
a distribution information storage step for storing distribution information in which at least one data broadcast program element identifier and a data broadcast program element distribution target are corresponded; and
a data broadcast program element distribution step for, on receiving notification of at least one produced data broadcast program element at the synthesis step, selecting a data broadcast program element whose identifier is shown in the distribution information, and distributing the selected data broadcast program element to the second broadcast station data broadcast program production apparatus, the second broadcast station data broadcast program production apparatus corresponding to the distribution target.

12. A computer-readable recording medium for use in a first broadcast station data broadcast program production apparatus and a second data broadcast station data broadcast program production apparatus, and having recorded there on a computer program that has a computer execute:
a template storage step for storing a template for a data broadcast program;
a synthesis step for, on receiving raw data, synthesizing the received raw data, using the template, to produce a data broadcast program element that composes a data broadcast program, and appending an identifier to the data broadcast program element;
a distribution information storage step for storing distribution information in which at least one data broadcast program element identifier and a data broadcast program element distribution target are corresponded; and
a data broadcast program element distribution step for, on receiving notification of at least one produced data broadcast program element at the synthesis step, selecting a data broadcast program element whose identifier is shown in the distribution information, and distributing the selected data broadcast program element to the second broadcast station data broadcast program production apparatus, the second broadcast station data broadcast program production apparatus corresponding to the distribution target.
